(19) United States
(12) Patent Application Publication
(10) Pub. No.: US 2013/0194410 A1
(43) Pub. Date: Aug. 1, 2013

(54) CELL OCCUPANCY MEASUREMENT

(71) Applicant: Ramot at Tel-Aviv University Ltd., Tel-Aviv (IL)

(72) Inventors: Gil TOPMAN, Ramat-Gan (IL); Amit GEFEN, Ganei Tikva (IL)

(73) Assignee: Ramot at Tel-Aviv University Ltd., Tel-Aviv (IL)

(21) Appl. No.: 13/804,810

(22) Filed: Mar. 14, 2013

Related U.S. Application Data
(63) Continuation-in-part of application No. PCT/IB2011/054025, filed on Sep. 14, 2011.
(60) Provisional application No. 61/511,061, filed on Jul. 24, 2011.
(60) Provisional application No. 61/442,852, filed on Feb. 15, 2011.
(60) Provisional application No. 61/382,581, filed on Sep. 14, 2010.

(51) Int. Cl. G06K 9/00

(52) U.S. Cl. CPC G06K 9/00127
USPC 348/79; 382/133

(57) ABSTRACT

A method for determining cell occupancy, confluency and cell migration in a cell culture, comprising receiving data related to pixel intensity in an image acquired of the cell culture, and distinguishing between cell concentrations in different locations in the cell culture by detecting variations in pixel intensity between multi pixel locations.

### RELATED APPLICATIONS

This application is a Continuation-in-Part (CIP) of PCT Patent Application No. PCT/IB2011/054025 filed on Sep. 14, 2011, which claims the benefit of priority under 35 USC 119(e) of U.S. Provisional Patent Application Nos. 61/382,581 filed on Sep. 14, 2010, 61/442,852 filed on Feb. 15, 2011 and 61/511,061 filed on Jul. 24, 2011.

The contents of the above applications are all incorporated by reference as if fully set forth herein in their entirety.

### FIELD AND BACKGROUND OF THE INVENTION

The present invention, in some embodiments thereof, relates to cell culturing and/or analysis, and more particularly, but not exclusively, to a device and a method for detecting cell occupancy and determining a culture's confluency, and/or cell count.

A culture's confluency is a fundamental measure in the field of biology. Confluency is used as a measure of the density of cells in a culture dish or a flask, and refers to the coverage of the dish or flask by the cells. For example, 100% confluency means that the dish is completely covered by cells and no more space is available for cells to grow, whereas 50% confluency means that roughly half of the dish surface area is covered, so there is still space available for cells to grow.

Processes in cell culturing, such as passaging (process of sub-culturing cells), induction of differentiation, or formulation of any repeatable experimental protocol, generally require that the confluency of cultures be carefully controlled and documented. Current techniques known in the art include qualitative estimation by a researcher, or use of chemical stains.

Other techniques known in the art include, for example, as described in US Patent Application No. 2006/0258018 “Method and Apparatus for Determining the Area or Confluency of a Sample”, which relates to “The area or confluency of a sample is determined by obtaining quantitative phase data relating to the sample and background surrounding the sample. The boundary of the sample is determined from the quantitative phase data by forming a histogram of phase data measurements and taking the derivative of the histogram to thereby determine the point of maximum slope. The line of best fit on the derivative is used to obtain a data value applicable to the boundary so that data values either above or below the determined data value are deemed within the sample.”

US Patent Application No. 2006/0280352 “Image analysis of biological objects” discloses “A computer-implemented method for analyzing images may include quantitatively analyzing image data to identify image objects relative to a background portion of the image according to predefined object criteria, the image data including a plurality of image objects that represent objects in a sample distributed across a substrate. The identified image objects are further clustered into groups or colonies of the identified image objects according to predetermined clustering criteria.”

US Patent Application No. 2006/0166305 “Animal cell confluence detection method and apparatus” discloses “an apparatus and process for detecting the degree of confluence of animal cells being cultured in a well plate. A well plate is arranged in an imaging station and illuminated with a ring of LEDs, or other optical source, from below at an oblique angle. An image of the well is captured with a CCD camera or other detector from above or below, such that the well image is taken in a dark field configuration where light from the optical source, if not scattered, does not contribute to the well image. By the simple solution of illuminating wells of a well plate from below at an oblique angle, it has been found that many animal cell types can be imaged with sufficient contrast to allow cell identification and consequent cell area computation using image processing techniques, thereby allowing confluence to be determined of animal cells being cultured in well plates.”

### SUMMARY OF THE INVENTION

There is provided in accordance with an exemplary embodiment of the invention, a method for determining cell occupancy in a cell culture comprising:

electronically receiving data related to pixel intensity in an image acquired of said cell culture; and

automatically distinguishing between cell concentrations in different locations in said cell culture by detecting variations in pixel intensity between at least a first multi pixel location and a second multi pixel location.

In an exemplary embodiment of the invention, variations in pixel intensity between the first multi pixel location and the second multi pixel location is indicative of a presence of cells. Optionally or alternatively, the method comprises identifying a denuded area based on a homogeneity in pixel intensity between the first multi pixel location and the second multi pixel location.

In an exemplary embodiment of the invention, wherein the detecting variations in the pixel intensity is done using first order statistics.

In an exemplary embodiment of the invention, the detecting variations in the pixel intensity is done using second order statistics.

In an exemplary embodiment of the invention, the detecting of variations in the pixel intensity is done by calculating standard deviation of the pixel intensities.

In an exemplary embodiment of the invention, the method comprises illuminating said cell culture with a source of a continuous spectrum of light.

In an exemplary embodiment of the invention, the method comprises windowing the received data with at least one window, wherein the detecting of variations in pixel intensity is performed over the windows. Optionally, a large window is used for said window and is of a size of at least 50% of a shortest string of a cell in said culture. Optionally or alternatively, an additional small window is used and is of a size of less than 50% of the size of the large window.

In an exemplary embodiment of the invention, the method comprises thresholding the variations in pixel intensity to find denuded areas. Optionally, the method comprises dilating of the denuded areas.

In an exemplary embodiment of the invention, the distinguishing is performed by combining results obtained from a plurality of windows.

In an exemplary embodiment of the invention, the received data is a grayscale image of said cell culture. Optionally, the grayscale image is taken using a phase contrast microscope.

In an exemplary embodiment of the invention, the received data is associated with a single image acquired of said cell culture.

In an exemplary embodiment of the invention, the method comprises estimating a cell count in said cell culture according to a size of areas occupied by cells and an average size of the cells in said cell concentrations.

In an exemplary embodiment of the invention, the method comprises automatically estimating cell movement by detecting changes in cell occupancy over time using a sequence of a plurality of images of said cell culture acquired over time. Optionally, estimating cell movement comprises estimating sperm motility by comparing time dependent displacements of spatial locations of cell populated areas in said images. Optionally or alternatively, estimating cell movement comprises estimating wound healing rate. Optionally or alternatively, estimating cell movement comprises estimating cancer cell metastasis.

There is provided in accordance with an exemplary embodiment of the invention, a device for measuring cell occupancy in a cell culture comprising circuitry configured to distinguish between cell concentrations in different locations in said cell culture by detecting variations in pixel intensity between at least a first multi pixel location and a second multi pixel location.

In an exemplary embodiment of the invention, variations in pixel intensity between the first location and the second location is used as an indication of a presence of cells. Optionally or alternatively, the circuitry is configured to calculate a percentage of confluency in said cell culture.

Optionally or alternatively, the circuitry is configured to apply a windowing function for detecting denuded areas in the image by windowing the received data with at least one window. Optionally, the received data is associated with a grayscale image of said cell culture. Optionally or alternatively, the received data is associated with a single image acquired of said cell culture.

In an exemplary embodiment of the invention, the circuitry is configured to apply a large windowing function and a small windowing function substantially in parallel for detecting denuded areas in the image by estimating texture variability in the windows.

In an exemplary embodiment of the invention, said circuitry is configured to estimate cell movement by detecting changes in cell occupancy over time.

In an exemplary embodiment of the invention, said circuitry is configured to estimate sperm motility.

In an exemplary embodiment of the invention, said circuitry is configured to estimate wound healing rate.

There is provided in accordance with an exemplary embodiment of the invention, a system for detecting cell occupancy in a cell culture comprising:

a device for measuring cell occupancy in a cell culture comprising a processor programmed to distinguish between cell concentrations in different locations by detecting variations in pixel intensity between a first multi pixel location and a second multi pixel location;
a microscope;

an image detector; and

a source of a continuous spectrum of light.

In an exemplary embodiment of the invention, the source of a continuous spectrum of light is a light source suitable for phase-contrast microscopy. Optionally or alternatively, the source of a continuous spectrum of light is a halogen lamp. Optionally or alternatively, the source of a continuous spectrum of light is indoor room illumination. Optionally or alternatively, the system comprises a mini-incubator for culturing cells.

In an exemplary embodiment of the invention, the microscope is a phase contrast microscope.

In an exemplary embodiment of the invention, said device is incorporated within said microscope.

There is provided in accordance with an exemplary embodiment of the invention, a system for cell observation comprising:

a microscope comprising a device for measuring cell occupancy in a cell culture comprising a processor programmed to distinguish between cell concentrations in different locations by detecting variations in pixel intensity between a first multi pixel location and a second multi pixel location; an image detector; and a source of a continuous spectrum of light; and

a cell maintenance unit.

There is provided in accordance with an exemplary embodiment of the invention, a method for culturing cells comprising:
incubating a cell culture;
electronically receiving data related to pixel intensity in an image acquired of said cell culture; and
automatically distinguishing between cell concentrations in different locations in said cell culture by detecting variations in pixel intensity between a first location and a second location.

In an exemplary embodiment of the invention, the method comprises illuminating said cell culture with lighting suitable for phase contrast microscopy. Optionally or alternatively, the method comprises illuminating said cell culture with nonpolarized light. Optionally or alternatively, the distinguishing comprises detecting denuded areas in the image by parallely windowing the received data using both a large window and a small window.

There is provided in accordance with an exemplary embodiment of the invention, a method for determining a cell count in a cell culture comprising:

electronically receiving data related to pixel intensity in an image acquired of said cell culture;

automatically segmenting said cell culture to areas occupied by cells and denuded areas by thresholding variations in pixel intensity between at least a first location and a second location, said variations indicative of presence of cells.

automatically determining a size of said areas occupied by cells in said cell culture; and

estimating the cell count in said concentration based on said size of said areas occupied by cells and an average size of cells.

In an exemplary embodiment of the invention, the method comprises computing the cell count automatically. Optionally or alternatively, the estimating of the cell count is done by dividing said size of said areas occupied by cells by said average size of the cells.

In an exemplary embodiment of the invention, the method comprises computing the cell count using linear regression.

In an exemplary embodiment of the invention, the method comprises computing the cell count using non-linear regression.

In an exemplary embodiment of the invention, the method comprises calculating said average cell size. Optionally, said average cell size is determined by counting pixels pertaining to a cell in an image of a segmented cell.

There is provided in accordance with an exemplary embodiment of the invention, a method for determining cell migration in a cell culture comprising:

electronically receiving data related to pixel intensity in a sequence of a plurality of images of said cell culture acquired over time;

automatically distinguishing between cell concentrations in different locations in said plurality of images of said cell culture by detecting variations in pixel intensity between at least a first location and a second location in each image of said plurality of images; and

comparing said cell concentrations and determining a change in said cell concentrations over time. Optionally, said determining comprises applying an asymmetric sigmoid curve-fitting function. Optionally, said curve-fitting function includes a Richard's function.

There is provided in accordance with an exemplary embodiment of the invention, a system for automatically determining cell confluency comprising:
a device for measuring cell occupancy in a cell culture comprising a processor programmed to distinguish between cell concentrations in different locations by detecting variations in pixel intensity between a first location and a second location; a microscope; an image detector; and a source of a continuous spectrum of light;
an incubator; and
an add-on cartridge adapted to accommodate a cell culture.

In an exemplary embodiment of the invention, said add-on cartridge includes a wound inflicting device for causing micro-damage to said cell culture. Optionally, said wound inflicting device is a micro-scratcher or micro-indentor. Optionally or alternatively, said cell culture in said add-on cartridge is viewable under a microscope.

There is provided in accordance with an exemplary embodiment of the invention, an add-on cartridge for use with a system for determining cell confluency, said add-on cartridge adapted to accommodate a cell culture.

In an exemplary embodiment of the invention, the cartridge comprises a wound inflicting device for causing micro-damage to said cell culture. Optionally, said wound inflicting device is a micro-scratcher or micro-indentor.

In an exemplary embodiment of the invention, said cell culture is viewable under a microscope.

In an exemplary embodiment of the invention, the cartridge comprises one or both of software and hardware for calculating confluency.

In an exemplary embodiment of the invention, the cartridge comprises an electronic connector to a microscope for receiving image data therefrom.

In an exemplary embodiment of the invention, the cartridge comprises an optical connector to a microscope for receiving an image therefrom.

There is provided in accordance with an exemplary embodiment of the invention, a method for measuring sperm cell motility comprising:

receiving data related to pixel intensity in two successive images acquired of sperm cell populated areas;

distinguishing between sperm cell concentrations in different locations by detecting pixel intensity between a first location and a second location in each image of said two images; and

comparing said two images and estimating a movement based on said change in concentration between said first location and said second location.

There is provided in accordance with an exemplary embodiment of the invention, a method of confluency curve fitting, comprising:

(a) collecting at least 10 measurements at different times of a confluency measure of a cell culture; and

(b) estimating a confluency change function from said measurements.

In an exemplary embodiment of the invention, said collecting comprises automatically collecting at least 100 measurements. Optionally or alternatively, automatically manipulating said culture as part of said collecting. Optionally, said manipulating comprises one or more of wounding and providing a chemical to said culture.

In some exemplary embodiments the large window is of a size of at least 50% of a shortest string of a cell in the culture.

In some exemplary embodiments the small window is of a size of less than 50% of the size of the large window.

In some exemplary embodiments the device is removably attached to the microscope.

In some exemplary embodiments the device is permanently attached to the microscope.

In some exemplary embodiments, a cell count includes a margin of error of less than or equal to 10%.

In some exemplary embodiments, the average cell size is determined by counting pixels in an image of a segmented cell.

There is provided, according to an embodiment of the present invention, a method for determining cell migration in a cell culture comprising receiving data related to pixel intensity in a sequence of at least three images acquired of said cell culture, distinguishing between cell concentrations in different locations in said cell culture by detecting pixel intensity between a first location and a second location in each image of said sequence of images, and comparing sequential images and determining a change in said cell concentration between said first location and said second location over time.

In some exemplary embodiments, determining includes applying an asymmetric sigmoid curve-fitting function.

In some exemplary embodiments, the curve-fitting function includes a Richard's function.

In an exemplary embodiment of the invention, the method comprises determining cell confluency in a section of a three-dimensional cell culture construct, said construct extending at least 3 mm in each direction.

In some exemplary embodiments, the method comprises determining cell migration in a tissue engineered three-dimensional construct.

In some exemplary embodiments, the three-dimensional construct comprises a chemotaxis gradient in at least two non-parallel directions.

In some exemplary embodiments, determining comprises acquiring at least one projection image of the three-dimensional cell culture.

In some exemplary embodiments, the image is acquired from a section selected from the three-dimensional construct, the section having a thickness small enough to visualize cells therethrough.

There is provided, according to an embodiment of the present invention, a method for detecting confluency in a three-dimensional construct, comprising imaging a three-dimensional construct comprising migrating cells, the construct having a shortest dimension of at least 1 mm, and analyzing an acquired image to detect at least one of confluency and cell migration using an automatic device.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings and images. With specific reference now to the drawings and the images in detail, it is stressed that the particulars shown are by way of example and for purposes of illustrative discussion of embodiments of the invention. In this regard, the description taken with the drawings and the images makes apparent to those skilled in the art how embodiments of the invention may be practiced.

In the drawings:

FIG. 1 schematically illustrates an exemplary functional diagram of a device for measuring a culture's confluency and/or optionally determining a cell count, according to some embodiments of the present invention;

FIG. 2 is a flowchart illustration of a method for detecting cell occupancy in a cell culture and optionally cell count, according to some exemplary embodiments of the invention;

FIG. 3A schematically illustrates an exemplary system for detecting cell occupancy and optionally a cell count in a cell culture, according to some exemplary embodiments of the invention;

FIG. 3B is a flowchart describing a general exemplary method for detecting cell occupancy and/or cell migration in a three-dimensional cell culture construct, according to some exemplary embodiments of the invention;

FIG. 3C illustrates an embodiment of a three-dimensional cell culture construct in which a section is selected from, according to some exemplary embodiments of the invention;

FIG. 3D is a flowchart describing a detailed exemplary method for detecting cell occupancy and/or cell migration in a three-dimensional cell culture construct, according to some exemplary embodiments of the invention;

FIG. 4 schematically illustrates a block diagram of an exemplary automatic cell culturing system, according to some embodiments of the present invention;

FIG. 5 schematically illustrates a block diagram of an exemplary system for automatically determining cell confluency, according to some embodiments of the present invention;

FIG. 6A illustrates an exemplary method for measuring cell migration in a cell culture, according to an embodiment of the present invention;

FIG. 6B schematically illustrates an exemplary system for continuously measuring kinematics in a cell culture, according to some exemplary embodiments of the invention;

FIG. 7 is a Table 1 listing parameters used in determining the confluency and optionally a cell count, according to some embodiments of the present invention;

FIG. 8 schematically illustrates a flow chart of an exemplary method for automatically measuring cell confluency used in an experiment, according to some exemplary embodiments of the present invention;

FIGS. 9A1-9C2 are visual measurements of cell confluency using the exemplary method of FIG. 8, according to some exemplary embodiments of the present invention;

FIGS. 10A-10C are time plots of cell confluency measurements using the exemplary method of FIG. 8, according to some exemplary embodiments of the present invention;

FIGS. 11A-11B4 are time plots of cell confluency measurements using the exemplary method of FIG. 8 and cell confluency measurements performed manually by technicians, according to some exemplary embodiments of the present invention;

FIG. 12 is a plot of estimated automatic cell count based on the method of FIG. 8 versus manual cell counts by the technicians, according to some exemplary embodiments of the present invention;

FIG. 13 schematically illustrates a flow chart of an exemplary method for automatically measuring cell migration used in an experiment, according to some exemplary embodiments of the present invention;

FIGS. 14A-14I are visual measurements of cell migration using the exemplary method of FIG. 13, according to some exemplary embodiments of the present invention;

FIGS. 15A-15D are quantitative A-t plots using the exemplary method of FIG. 13, according to some exemplary embodiments of the present invention;

FIG. 16 is a table listing the culture migration properties and corresponding Richard function coefficients used with the exemplary method of FIG. 8, according to some exemplary embodiments of the present invention;

FIG. 17 schematically illustrates a flow chart of an exemplary method for automatically determining a wound area used in an experiment, according to some exemplary embodiments of the present invention;

FIGS. 18A1-18C4 are images of the difference in the migration kinetics of the cultures from the NIH3T3, 3T3L1 and C2C12 cell types using the exemplary method of FIG. 17, according to some exemplary embodiments of the present invention;

FIGS. 19A1-19C are plots of examples of time course and intra-wound cell counts determined using the exemplary method of FIG. 17, according to some exemplary embodiments of the present invention;

FIG. 20 shows two tables with the results of the ANOVA and post-hoc Tukey tests comparing the migration of the cells in the experiment, according to some embodiments of the present invention;

FIGS. 21A-21B are graphs generated using the exemplary method of FIG. 17 of maximum and average migration rate as a function of the ischemic conditions, according to some exemplary embodiments of the invention;

FIGS. 22A and 22B are graphs generated using the exemplary method of FIG. 17 of TOMCM and TEMCM as a function of the ischemic conditions, according to some exemplary embodiments of the invention.

FIGS. 23A and 23B illustrate an experimental setup for measuring confluency and cell migration rate in a three-dimensional cell culture construct, according to some exemplary embodiments of the invention; and

FIGS. 24 A1-2 and B1-2 are visual measurements of cell confluency in micrographs of a three-dimensional cell culture construct, according to some exemplary embodiments of the invention.

### DESCRIPTION OF SPECIFIC EMBODIMENTS OF THE INVENTION

The present invention, in some embodiments thereof, relates to cell culturing and/or analysis and, more particularly, but not exclusively, to a device and a method for determining a culture's confluency and/or cell count. Throughout the application a confluency measurement device refers to the device for determining a culture's confluency and/or cell count.

An aspect of some embodiments of the present invention relates to detecting cell occupancy in a cell culture by texture analyses of the culture. Optionally, detecting of the cell occupancy is used for evaluating a cell culture's confluency. Additionally or alternatively, detecting of the cell occupancy is used to measure a distribution of the cells in the culture, and may include, for example, identifying larger and/or smaller areas of cell concentrations. Optionally, contours of individual cells in the culture may be identified. Optionally, detection is over a time course, for example as related to cell mitosis and/or cell death and/or cell growth, or to cell migration during wound healing where changes in cell confluency in a particular area are measured over time or as related to cancer cell metastasis, or to sperm motility, or to migration of immune system cells. Optionally, cell movement is by comparing a measurement to a known base line (e.g., a location where cells were not in existence before.

In some exemplary embodiments, the cell culture is a two-dimensional culture, for example being in the form of a planar layer of cells (monolayer culture). However, in some embodiments, the cell culture is a three-dimensional culture, for example being in the form of a multi-layer of cells. Optionally, the three-dimensional cell culture extends, for example, at least 3 mm, 5 mm, or 10 mm in one, two and/or three directions.

In some exemplary embodiments, a three-dimensional cell culture comprises transparent extracellular matrix, and images of the cell culture can be acquired through the transparent matrix. In some embodiments, for example if the matrix is murky and/or contains many cells (that may result in an unclear projection image), a section of the construct, for example a thin section such as having a thickness of at least 0.5 mm, 0.7, 1 mm, optionally a two dimensional section, is imaged. In some embodiments, a thicker transparent section, such as having a thickness of at least 2 mm, 4 mm, 7 mm is imaged. In some embodiments, a section close to an external surface of the construct is imaged, for example a 2 mm section, such as to avoid a murky volume of the matrix.

In some exemplary embodiments, the image is a projection image in which the three-dimensional construct comprising the cells is projected onto a two dimensional image plane. Additionally or alternatively, multiple images of layers of the construct are acquired. Additionally or alternatively, selective imaging of a segment of the construct is performed, for example using computed tomogoraphy methods which include, for example, acquiring multiple projections of the cell culture.

In some embodiments, a digital image which is a grayscale image of the cell culture may be captured using a light microscope, for example a phase contrast microscope, and an image detector, for example, a digital camera. Optionally, the image detector is a CCD (charge coupled device) or CMOS camera. The confluency measurement device may include a processor adapted to segment the image and measure the cell occupancy. Optionally, the processor detects denuded regions therein, wherein denuded regions are areas not covered by cells. The processor may include sufficient memory (not shown) for storing at least two grayscale images of a same size. In some embodiments, the confluency measurement device may include a cell maintenance unit such as, for example, an incubator, cell culturing unit or an isolated chamber for culturing the cells. Optionally or alternatively, the device includes or is part of a means for manipulating the cells, for example, by exposure to radiation fields or by modifying their environment (e.g., pipette delivery). Optionally, a large scale parallel cell culturing and manipulation system is used, with, for example, more than 100 or 1000 cultures being processed in parallel and imaged, for example, in parallel or in series (e.g., moving a microscope and/or the cultures). Optionally, the confluency measurement device may include a display for presenting cell occupancy data and any other relevant data. In some exemplary embodiments of the invention, a pixel is a portion of a digital image which image is segment, for example, using a grid (e.g., a rectangular grid) or other regular, possibly non-homogenous, pattern.

In some exemplary embodiments, phase contrast illumination is used to illuminate the cell culture, or a sample of the culture. Optionally, the sample is illuminated from below and observed from above, so that light is transmitted through the sample and the micrograph is formed due to absorbance of some of the transmitted light in denser areas of the sample. In some embodiments, a phase contrast light (illumination) source is a halogen light source or any other light source suitable for producing a continuous spectrum of light. In an exemplary embodiment of the invention, the spectrum includes a range of at least 100 nm, 200 nm, 400 nm or intermediate continuously provided wavelengths of light.

In an exemplary embodiment of the invention, non-polarized illumination is used to illuminate the culture, or the sample of the culture. Optionally, the illumination is modulated for the time of image acquisition. In some embodiments, a brightfield illumination method is used for brightfield microscopy. Optionally or alternatively, imaging using dyes, florescence or other methods which interfere with cells may be used for image acquisition.

In an exemplary embodiment of the invention, cell occupancy is determined from a single image (the original image) by determining texture variability in the image. Optionally, a variability of pixel intensities associated with different cell concentrations is determined between a first location and at least a second location in a window within a field of view of the microscope. The texture variability may be determined using statistical methods for estimating pixel intensity variability within a selected window of the image. Optionally, texture variability may be determined using first order statistics applied to the pixel intensities in the image, which may include, for example, standard deviation, kurtosis, or skewness. Alternatively, second order statistics may be applied to the pixel intensities, for example, co-occurrence matrices or autocorrelation functions. A pixel can be a portion of a digital image divided up using a grid or other regular pattern. In some embodiments, if the window does not contain cells, it is treated as “background” having a substantially uniform intensity so that the variability of intensities in that “empty” window becomes very low. Optionally, if cells are present in the window, the variability of the pixel intensities increases with relation to the number of cells.

In some exemplary embodiments, segmentation is performed according to areas populated by cells and areas denuded of cells. Optionally, the areas populated by the cells are identified by their image having a more inhomogeneous texture relative to the image of the denuded areas. In some embodiments, the denuded areas are identified by their image having a more homogeneous texture relative to the image of cell populated areas. Optionally, the culture confluency may be calculated using the following equation (1):

$$\% confluency = ( 1 - \frac{number\_of \_denuded \_pixels}{total\_number \_of \_pixels} ) \times 100 \qquad ( 1 )$$

In some exemplary embodiments, the size of the window is at least half of a cell's shortest string, for example 30 μm for NIH3T3 cells. The term cell's shortest string relates either to the cell's width or the cell's length, whichever is shorter. Alternatively, more than one window function may be applied to a light microscopy image. For example, two window functions may be utilized in parallel. The sizes of the windows of the different window functions may be different. For example, when using two window functions, the size of the window of the first window function may be at least half of a cell's shortest string, while the size of the window of the second window function may be one third of the size of the window of the first window function. Alternatively, other window sizes may be used.

In some exemplary embodiments, the large window is of a size of at least 40% of the cell's shortest string, for example, at least 50%, at least 60%, at least 80%, at least 100%. Optionally, the small window is of a size that detected areas are close to the edges of the window, for example, less than or equal to 60% of the size of the large window, less than or equal to 40%, less than or equal to 30%, less than or equal to 20%, less than or equal to 10%. For example, if the large window for the NIH3T3 fibroblast cells is 30 μm, a size of the small windowing function may be, for example 10 μm. Optionally, the standard deviation is used as homogeneity measure. Alternatively, any other suitable homogeneity measure is used, for example, that of a gray level co-occurrence matrix. The windows may be rectangular, although in some embodiments the windows may include other shapes known in the art such as for example, Gaussian, triangular, cosine, and the like.

In some exemplary embodiments, the windowed images (i.e. the resulting images from the windows) are subject to thresholding (thresholding function) for detecting the homogeneous regions. Optionally, the homogeneous regions are identified using low standard deviation values, for example, less than 0.1, less than 0.75, less than 0.55, less than 0.4, less than 0.25. In some embodiments, thresholding includes use of Otsu's method, Riddler's method, or any other suitable precalibrated manual threshold or auto-threshold algorithm. Optionally, the threshold of the large window is the same as that used for the small window.

In some exemplary embodiments, the resulting images from the windows are subject to dilation (dilation function) for acquiring areas close to the edges of the original image. Optionally, only the resulting image from the large window is dilated. The dilation of the image from the large window may be dilated with a structure at least 40% of the size of the large window, for example, 50%, 60%, 70% or greater. Optionally, the dilation structure is a rectangular window or any other window type for providing the required dilation.

In some exemplary embodiments, the resulting image from the large window and that from the small window are combined to form a single image. Optionally, the image from the large window includes cell concentration areas far from the edges of the original image. In some embodiments, the resulting image from the small window includes cell concentration areas close to the edges of the original image. Alternatively, the resulting image from the large window includes denuded areas far from the edges of the original image and the resulting image from the small window includes denuded areas close to the edges of the original image (and substantially none from within the cells).

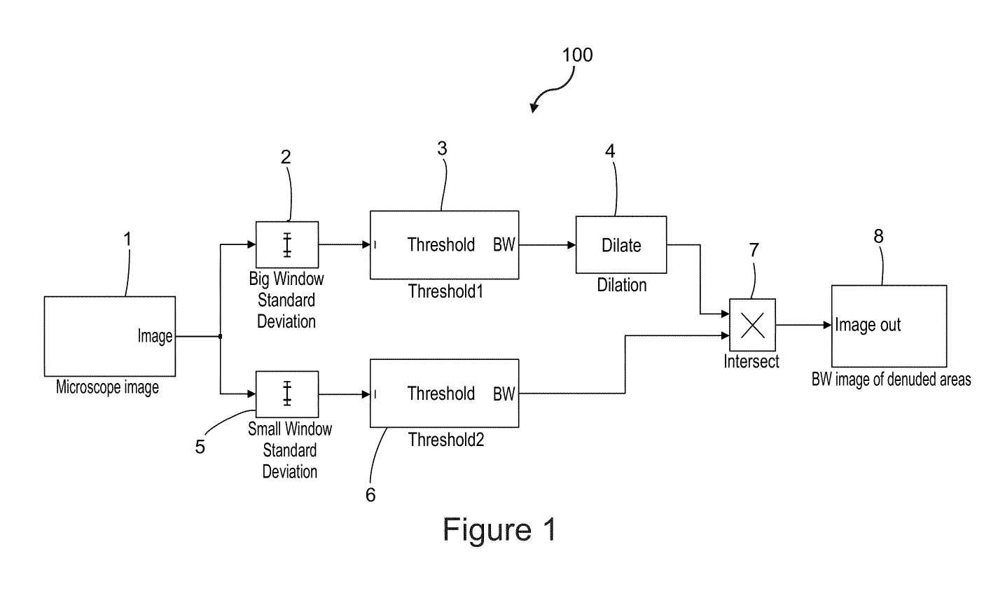

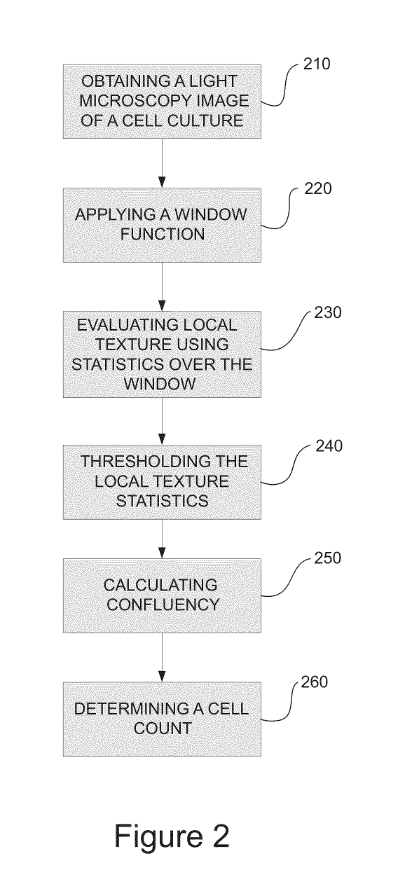

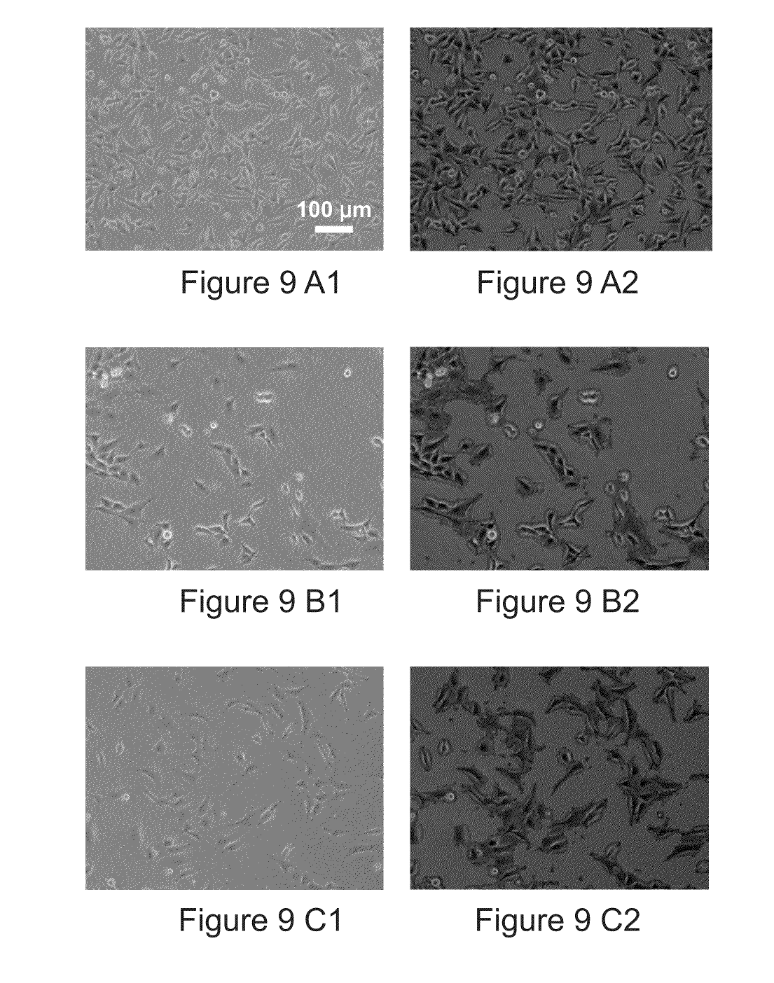

In some exemplary embodiments, image preprocessing of the whole micrograph or of each selected window, such as histogram equalization or fixing uneven illumination or other equivalent image preprocessing methods known in the art, can be used for improving the quality of image data before further processing is made (i.e., according to FIGS. 1 and 2 below) for eventually improving the accuracy in measurements of cell occupancy or confluency. Spatial filtering algorithms known in the art such as averaging or Gaussian filtering or any other spatial filtering methods known in the art can be further applied to the entire micrograph or to each selected window in order to reduce errors in calculation of cell occupancy or confluency. For example, it was found that when applying spatial filtering in the wound healing experiment described further on herein (i.e., FIG. 9 below), local errors in determining confluency were reduced by up to 15%.

An aspect of some embodiments of the present invention relates to automatically estimating a cell count in a culture. Optionally, the cell count is estimated by performing a confluency measurement using texture analysis/segmentation of the culture. In some embodiments, the cell count is based on the confluency measurement and an average size of the cells in the culture.

In some exemplary embodiments, the cell count is estimated by determining the area covered by the cells in the culture (area of confluency) and dividing by an average size of the cells, and is given by the following equation (2):

Cell count=(% confluency×Afov)/(average cell area) (2)

where Afov is the area of the field-of-view of the microscope in mm2, the average cell area is the average area of cells projected on the two-dimensional plane of the image (i.e. the cell base area), and % confluency is calculated as previously disclosed. Optionally, an accuracy of the estimation is based on a variability in the size of cells of the same type so that, estimating a cell count of cells having a substantially same size will result in a more accurate estimate compared to cell counts of cells having relatively large size variability. For example, cell count in cultures of C2C12 or of 3T3-L1 cells, which have relatively small size variability, can be more accurate than cell counts for cultures having cell with large size variability, for example, NIH3T3 culture.

In some exemplary embodiments, the average size of the cells is determined automatically by counting pixels within imaged segmented cells. Optionally, a software application is used for the automatic counting, such as for example, a Matlab software application. Optionally, the average cell size is determined from a sample of the segmented cells. Alternatively, the average cell size is determined manually by measuring the size of the cells in the image. Alternatively, the average size of the cells is known in the art, and is not determined.

In some exemplary embodiments, the method for automatic cell counting disclosed is useful for research applications such as, for example, when growing cells for an experiment where repeatability across trials is of importance. Optionally, the method for automatic counting is useful in medical applications involving monitoring cell division, for example, for in-vitro fertilization. Other medical applications may include toxicity assay applications, for example, as for when testing medications.

In some exemplary embodiments, the method was verified by comparing the automatic cell count with a manually performed cell count. The images of the segmented cells were visually inspected for correctness of segmentation of denuded areas. Cell counts were further estimated based on the area populated by cells detected. The cell count was approximated by equation (3):

count=α(A_{FOV}×%confluency)+β (3)

α and β were evaluated in a calibration process, by linear regression against manual cell counts in the same micrographs used for calculating % confluency (n>=10 micrographs per each cell type). The accuracy of the automatic cell count was evaluated using the normalized root mean square error (NRMSE) per equation (4):

$$NRMSE = \sqrt{\frac{{\sum }_{i} {( {\hat{X}}_{i} - {X}_{i} )}^{2}}{{\sum }_{i} {X}_{i}^{2}}} \qquad ( 4 )$$

where Xᵢ is the manual cell count and is the corresponding cell count determined from the above equation.

In some exemplary embodiments, α and β may be empirically determined coefficients obtained from a calibration process including linear regression of automated cell counts (employing the objective function of minimal sum of squared error) with respect to manual count data from the analyzed images. Optionally, α and β are determined by linear regression of calculated cell counts versus manual cell counts for a sample of micrographs. Alternatively, α and β may be determined by other estimation methods. The values of α and β that provide the minimal sum of squared errors between calculated cell counts and manual counts are the outcome of the linear regression analysis. Optionally, α and β are specific to each cell type and are pre-determined in a calibration process, based on comparison to manual counts as previously described, prior to using the method with a certain cell type. Additionally or alternatively, α and β are independent of confluency level and, once determined for a certain cell type, may be used at any confluency level.

In some exemplary embodiments, using linear regression for determining the cell count is potentially advantageous as it has a relatively small number of parameters for which values need to be estimated (α and β). Alternatively, higher-order functions (e.g. polynomials) may be used with nonlinear regression with a potential benefit of better accuracy of automated cell counts, but a disadvantage of needing to define and fit more parameters. Additionally or alternatively, nonlinear regression may be used for determining the cell count for some cell types and linear regression used for other cell types. In some embodiments, nonlinear regression may be used for cell types having relatively large size variability compared with the average size, for example, greater than 10%, 15%, 20%, or more. Optionally, linear regression may be used for cell types having a relative small size variability compared to the averages size, for example, less than 15%, 10%, 8%, 5%, or less.

In some exemplary embodiments, calibration of the method is based on the size of the cells in the culture, for example, the bigger the cell the bigger the window. Optionally, the window size may be selected so that the cells are on the edge of the image.

In some exemplary embodiments, the invention contributes to potentially substantial improvements over cell occupancy detection/measurement and/or cell counting methods known in the art. For example, use of complex microscopic viewing devices is not required; instead a relatively simple microscope such as, for example, phase contrast microscope employing basic phase contrast optics is used. Optionally, the microscope does not require any modifications of the standard (phase contrast) optics or additional optical pieces such as additional illumination sources or lenses. For example, use of oblique illumination sources and lenses is not required.

In some exemplary embodiments, the microscope, including optical hardware, may include a single phase contrast light source (illuminator) whose light is directed towards a condenser lens below a stage in the microscope. Optionally, the illuminator is built into the microscope, although in some embodiments, the illuminator is not attached to the microscope. For example, in some embodiments, the illuminator may be room illumination directed towards the condenser which focuses the light on the sample. Optionally, the light travels from the illuminator through the condenser lens, through the sample, then through an objective lens, and to the imaging device through an ocular lens. In some embodiments, the condenser is adjustable and may include an aperture diaphragm (contrast) for controlling a diameter of the light beam passing through the condenser. Optionally, the opening of the condenser may be adjustable for changing the resolution and contrast of the image. In some embodiments, the stage is a mechanically-adjusted stage for holding the sample, and may be moved upwards or downwards so that a relevant horizontal plane in the sample is brought into focus. In some embodiments, the imaging device is connected to a computer for recording and archiving the observed micrographs.

In some exemplary embodiments, a potentially additional advantage over the current art is that processing requirements and memory storage requirements may be substantially minimized as only one image of the culture is required as input (two images are stored, that in the large window and that in the small window). Additionally, the method is not sensitive to illumination conditions, and therefore does not require contrast or illumination achieved by special optics. Additionally, no prior assumptions are made regarding the image of the cells, for example, the shape of the intensity histogram of their image.

In some exemplary embodiments, a potentially additional significant advantage over the art is that the cultures may be kept alive before, during, and after the examination as there is no intervention of a chemical or intervention of other nature, such as use of staining or flow cytometry, with the cells or the culture conditions. Furthermore, continuous monitoring of the culture to quantify cell mitosis, death, growth, culture development, and the like is possible. Optionally, detection of denuded areas in the image is possible which may be useful, for example, in studying cancer metastasis models, wound healing models, and other applications involving cell migration.

In some exemplary embodiments, a potentially additional advantage is that physical presence of a researcher in the laboratory may be reduced when performing qualitative estimation of confluency during prolonged experiments or if a large number of such estimations is needed. Additionally, qualitative estimation of confluency by a researcher is subjective, often not repeatable, prone to errors, and potentially prohibits possible automation of cell culturing processes. Furthermore, using chemical stains may result in cell death in the culture and involves costs in terms of consumables and equipment.

In some exemplary embodiments, a system for detecting cell occupancy and optionally cell count in a cell culture includes the confluency measurement device and a microscope. Optionally, the confluency measurement device includes an electronic chip adapted to be physically connected to the microscope. Optionally, the confluency measurement device is removably attached to the microscope. Alternatively, the confluency measurement device is permanently attached to the microscope. In some embodiments, the chip may include optics for viewing the cell culture.

In some embodiments, the confluency measurement device is implemented in a computer connected to the microscope, which can be either a desktop/laptop/notebook computer or a handheld computer, or it can be a dedicated computer, which can be either integrated with the microscope or stand-alone. Optionally, the computing unit can be connected to the microscope through a wired and/or a wireless connection, which may be from a remote location (for remotely performing the calculations and determining the cell occupancy and optional cell count), for example from a distance of 1 meter, 10 meters, 100 meters, 1000 meters, or more.

In some embodiments, quantitative measurement of the confluency of a culture and other outputs may be displayed on the computer. Additionally or alternatively, the outputs including quantitative measurement of cell occupancy, which may include confluency, may be displayed on a display on the microscope itself, for example an LCD (liquid crystal display). Additionally or alternatively, the outputs which may include quantitative measurement of cell occupancy or confluency may be presented as audio. In some embodiments, the outputs including quantitative measurements of cell occupancy or confluency may be sent to the remote location automatically or can be programmed to be sent to a remote location automatically, for example via an e-mail message, a data file sent through computer wired or wireless communication, via a text or multimedia message delivered to a cellular phone such as short message service (SMS), or via fax communication. Optionally, the outputs are used to control the confluency measurement from the remote site.

In some embodiments, the quantitative measurement of cell occupancy/confluency data may be integrated into automatic processes of cell culturing such as robotic devices that may perform cell passaging or cell differentiation for purposes such as laboratory medical examinations or tissue engineering applications. Optionally, the automatic processes include remote monitoring using one or more microscopes with one or more robots for moving the cells into the microscope, when needed, wherein the control and information processing is from the remote location. In some embodiments, the robotic device includes a robot with the methods/devices disclosed herein integrated in the robot, or added on to the robot. In some embodiments, the system includes an image detector. Optionally, the system further includes an incubator or an isolated chamber for culturing the cells, so that their mitosis, death, growth, or response to chemical, mechanical, electrical, combined or other stimulus, or their behavior, or any combination thereof, can be observed and monitored quantitatively in real-time, and/or recorded in a computer or using a data storage device.

In some exemplary embodiments, a system for cell observation which may be a system for automatic culturing of cells includes the confluency measurement device and a phase contrast microscope located in an incubator. Additionally or alternatively, a mini-incubator is mounted on the phase contrast microscope. Optionally, cell confluency, cell migration, metastasis, sperm motility, effects of ischemia on cell cultures, and the like may be monitored and detected automatically over a lifetime of the culture. In some embodiments, the system may be integrated in medical laboratory assays where cell culturing is required for performing medical exams, such as, for example, blood culture or biopsy culture. Optionally, the system may be used for automatic monitoring of the growth of bone marrow cells given to leukemia patients in order to replace cells killed by chemotherapy. Additionally or alternatively, the system may be used for automatically monitoring the development of in vitro fertilization. Optionally, the system may be used for standard biomaterials testing, where a cell culture assay is commonly being used to assess the cytotoxicity of materials designed or manufactured for the purpose of implantation. Additionally or alternatively, the system may be used for standard pharmaceutical cytotoxicity testing, where the effects of compositions of newly developed drugs or experimental doses of existing drugs are being tested.

In some exemplary embodiments, the confluency measurement device is embodied as an add-on cartridge including a processor and a software package for automatic measurement of confluency. Additionally or alternatively, the add-on cartridge includes a software package for automatic measurement of cell migration. Additionally or alternatively, the add-on cartridge includes a software package for automatic measurement of sperm motility. Additionally or alternatively, the add-on cartridge includes a software package for automatic determination of the effects of ischemia on wounds. In some embodiments, the software may be downloaded from a website. Optionally, the software may be obtained as an application package.

In some exemplary embodiments, the add-on cartridge is configured to be connected to a microscope or other suitable imaging device for acquiring images of cell cultures. Optionally, the add-on cartridge is interchangeable with another so that one cartridge is used for performing one type of measurement, for example, confluency measurement, while the other cartridge is used for cell migration measurements.

In some exemplary embodiments, a system for automatic culturing of cells includes the confluency measurement device having the add-on cartridge(s) as described above, and an incubator. Optionally, the system may include a wound inflicting device for creating a wound, such as, for example, a micro-scratcher or a micro-indentor. In some embodiments, the wound inflicting device may be manually operated. Alternatively, the wound inflicting device is automatically operated.

A comparison of automatic confluency measurements was made by the inventors using the method for detecting cell occupancy described herein, according to an exemplary embodiment, with visual measurements made by 4 professional personnel experienced in confluency measurements. The results showed the automatic confluency measurements as being in the midrange of that of the visual measurements measured over a time course of 80 hours. The results also showed variations in the visual measurements of a same person at different times, indicative of a subjective visual variability.

An aspect of some embodiments of the present invention relates to a method for measuring the kinematics of a cell culture. The method, in some embodiments, may be used to evaluate the effect of a medication, or culture, or environment, or other treatment, or cell-line, or correlation with other measurements done before or after, on the motility of cells (including dose effects). Additionally or alternatively, the method may be used to evaluate the effect of a food component or food supplement on the motility of cells. Additionally or alternatively, the method may be used to evaluate the effect of a toxic agent on the motility of cells. In some embodiments, the method may be applied to cancer research, for example, for evaluating anti-metastatic drug treatments, or chemotherapy agents, or radiation, or thermal therapy (hyperthermia, cold ablation), or focused ultrasound therapy on the motility of cancer cells. In some embodiments, the method may be used in wound repair research, for example, for evaluating drugs or medications that have the potential of accelerating repair and healing, and of food supplements or vitamins considered or assumed to accelerate wound healing by, for example, improving the motility of cells. In some embodiments, the method may be used for researching the influence of ischemic factors on the migration rates of cell types involved in cutaneous and subcutaneous pressure ulcers. In some embodiments, the method may be used to evaluate by applying, or by withholding, or by modifying environmental conditions, such as, for example, temperature, pH of culture media, glucose concentration, available oxygen level, electrical or magnetic fields, the effect on cell motility.

In some exemplary embodiments, the method includes any one of, or any combination of the methods, devices, and systems previously described for automatically measuring confluency. Alternatively, any method of measuring confluency may be used. The method includes matching data points determined by measuring the wound area over a sequence of time intervals using a particular family of the generalized (asymmetric) logistic curve-fitting functions, for example the Richard's functions. In some embodiments, a number of data points used is greater than 2, for example, 3, 5, 10, 20, 50, 200, 500 or more, for example, up to the sampling rate of the microscope system used in the specific setup, multiplied by the duration of the experiment. The method, in some embodiments, was used in experiments conducted by the inventors wherein micrographs were sampled every one minute, for a period of ˜24 hours, which provides ˜1440 data points.

The inventors have found that kinematic measurements using the method are at least 20%, and even 30%, more precise than the art which generally uses two data points in the measurements. The increased precision provides for greater measurement sensitivity and allows for detection of changes of approximately 10% whereas the art is unable to detect such changes. The art is currently not able to detect such changes due to factors such as, for example, use of subjective estimates that vary across observers or even vary for the same observer at different times; inaccuracy of manual measurements; use of chemical dyes or other destructive methods for evaluating cell density which do not allow monitoring the same culture over time. These factors may result in more costly experiments, and as a result may limit the number of experiments which may be conducted possibly reducing statistical power.

In some exemplary embodiments, the method is used for automatically determining a cell migration rate. Optionally, a time for onset of mass cell migration (TOMCM) is automatically determined wherein TOMCM is the time when X % of the wound is covered by migrating cells. Optionally, 5<X<95, for example X=6, 10, 15, 20, 25, 35, 50, 60, 70, 80, 90. Additionally or alternatively, a time for end of mass cell migration (TEMCM) is automatically determined, wherein TEMCM is the time when Y % of the wound is covered by migrating cells, and Y>X. Optionally, 10<Y<100, for example Y=10, 15, 20, 25, 35, 50, 60, 70, 80, 95. The method includes imaging at least a portion of a cell culture and, according to pixel intensities in the image, segmenting the portion into areas populated by cells and areas denuded of cells (wounds). In some embodiments, the method may be used for measure cell migration in cell cultures not having wounds, for example, for determining sperm motility or endothelial motility. Optionally, gradients of chemicals may be applied to the cell culture using methods known in the art.

In some exemplary embodiments, any of the above described methods and/or combinations thereof are used for automatically determining confluency, cell occupancy and/or cell migration in a three-dimensional cell culture, for example a multi-layered cell culture comprising a single or multiple cell types. A three-dimensional construct may include the three-dimensional cell culture sustained in a transparent or translucent extracellular matrix. The extracellular matrix may include transparent or translucent gel such as agarose gel, hydrogel, or any other suitable material, as well as materials for promoting cell growth, proliferation, differentiation, migration or synthesis of biological extracellular components, as needed. Optionally, the cells are marked and/or stained, for example fluorescently stained, to visualize the cell bodies and/or nuclei and/or any other cell organelles as relevant, under a fluorescence microscope.

In some embodiments, determining confluency in a three-dimensional construct includes acquiring an image of the three-dimensional construct. Optionally, an image is acquired through the transparent extracellular matrix. Optionally, the image is a two dimensional projection of the cells in the construct. In some exemplary embodiments, a section is removed from the construct, and the image is a two dimensional projection of the cells in the section.

In some embodiments, the microscope and/or illumination are adjusted to obtain only a specific volumetric portion of the section. In some embodiments, the microscope and/or image detector and/or viewed section are rotated. Optionally, multiple images of sections of the construct are combined and reconstructed to produce a three-dimensional view of the cell culture.

In some exemplary embodiments, the shape and direction of cell migration, for example through a three-dimensional construct, are visualized, for example by acquiring a projection image of the migrated cells. For example, the direction of cell migration can be vertical, horizontal, and/or diagonal in relation to the external surfaces and edges of the construct. Optionally, the morphology of the migrating cells comprises various shapes, for example cells may be arranged in a stripe, a semi-circle, or a curvy line. Optionally, the morphology of the migrating cells is affected by various types of stimuli, for example, chemicals and/or biochemicals added to the culture, for example to a surface and/or to one or more locations inside the volume of the construct. Optionally, the morphology of the migrating cells is affected by a mechanical or electrical stimulus. In one example, a mechanical stimulus is a mechanically induced wound. In another example, an electrical stimulus is applies using electrodes which may be inserted to the volume of the construct.

In some exemplary embodiments, cell migration rate is determined by analyzing micrographs acquired (possibly being micrographs of various sections) at various time points, for example between 5-10 hours, 18-24 hours, or 2-6 days post seeding. Optionally, cell migration rate is calculated using the average migration distance obtained at various time points.

In some exemplary embodiments, the method for determining cell migration rates in a three-dimensional construct comprises direct measurement of the collective migration rate of cells through the construct, rather than, for example, averaging migration rates of numerous individual cells. In some exemplary embodiments, the method is used in large scale screening experiments, for example to detect the effect of a drug such as an anti-metastatic medication on migration of cells. Optionally, the method is used for determining cell migration in tissue-engineered three-dimensional constructs. In some exemplary embodiments, other methods are used for determining cell migration, for example by simply detecting a certain distance between the location of cells and a starting point.

In some exemplary embodiments, the wounds are mechanically induced in the culture, for example, by “scratching”. Additionally or alternatively, the wounds may be induced thermally, for example, by exposure to focal heat or cold. Additionally or alternatively, the wounds may be induced chemically, for example, by locally exposing the culture to a toxic agent. Additionally or alternatively, the wounds may be induced by an electrical field, by exposing the culture to a local electrical current density. Images of the portion are then captured at intervals, optionally regular intervals, for detecting variations in pixel intensities or confluency in the wound area due to cell migration. In some embodiments, segmentation is performed for each image for determining the wound area for each time interval.

An aspect of some embodiments of the present invention relates to a method for measuring sperm motility by comparing time-dependent displacements of spatial locations of cell-populated areas in time-lapsed micrographs. In some embodiments, the method includes use of any one of, or any combination of, the methods, devices, and systems previously described for automatically measuring confluency. When sperm movement is relatively small the displaced cell-populated area is also small, but, when motility increases, the displaced areas rise accordingly. Optionally, sperm motility is determined by measuring confluency change.

In some exemplary embodiments, the displacement is determined by comparing cell-populated segmentation maps corresponding to two sequential time steps in a time-lapse microscopy dataset of micrographs. Optionally, the displacement is determined over a greater number of sequential images, for example, 3, 4, 5, 10, or more images. In the two images, the number of pixels which changed their segmentation assignment, i.e. “cell-populated area” pixels which have changed to “denuded area” pixels and “denuded area” pixels which have changed to “cell-populated area” pixels in a corresponding spatial location are counted. To obtain a measure which is independent of the image size, a percentage of displaced pixels between the segmentation maps are considered, given by equation (5):

$$Displacement = \frac{1}{NM} {\sum }_{x = 1}^{N} {\sum }_{y = 1}^{M} \vert {I}_{1} ( x , y ) - {I}_{2} ( x , y ) \vert \times 100 \qquad ( 5 )$$

where I₁ and I₂ are sequential “cell-populated area” binary segmentation maps of size N×M pixels each. Optionally, the displacement is calculated for each such sequential pair of “cell-populated area” binary segmentation maps in the dataset for yielding a time course of displacements which represents the motility performances of the sperm under observation, over time. Optionally, the time interval between the compared micrographs should be short enough such that sperm cell bodies in new locations will not overlap different cells in their original locations. The time interval may range from 1 second to 10 hours, for example, 5 seconds, 60 seconds, 10 minutes, 60 minutes, 3 hours, 6 hours, 9 hours.

An aspect of some embodiments of the invention relates to fitting a curve using multiple confluency measurements, optionally, but not necessarily, measurements collected using methods described herein. Other methods may be used as well. However, a potential advantage of the methods described herein is reduced interference with the culture and/or reduced manpower need. In an exemplary embodiment of the invention, fitting is using an asymmetric sigmoid, for example a sigmoid function. Optionally, the multiple measurements include at least 4, 10, 20, 50, 100, 400 or more measurements. Optionally, such curve fitting is used for estimating wound healing.

Some embodiments of the present invention may be implemented in software for execution by a processor-based system. For example, embodiments of the present invention may be implemented in code and may be stored on as nontransitory storage medium having thereon instructions which can be used to program a system to perform the instructions. The nontransitory storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom-made, or off-the-shelf hardware, firmware, or a combination thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings, FIG. 1 schematically illustrates a functional diagram of an exemplary device 100 for measuring cell occupancy in a cell culture, according to an embodiment of the invention. As previously discussed, measuring cell occupancy may be used to measure migration and/or motility and/or healing, so that in some embodiments, device 100 may be used for measuring cell migration and/or for measuring sperm motility. Device 100 includes functional blocks which may be implemented as hardware and/or software, and include a microscope imaging function 1, a large (big) windowing function 2, a large window thresholding function 3, a dilation window function 4, a small windowing function 5, a small window thresholding function 6, an image combining function 7, and a cell occupancy image reproduction function 8. Optionally, large windowing function 2, large window thresholding function 3, and dilation window function 4, are serially arranged, and are arranged in a parallel processing configuration with serially arranged small windowing function 5 and small window thresholding function 6,

In some exemplary embodiments, the image acquired by the digital camera through the light microscope is a grayscale image dividedly processed by microscopic imaging function 1 into two images for parallel processing by device 100. Optionally, parallel processing is used for detection of different areas of cell concentrations in the image. Optionally, an area of cell concentration is substantially inhomogeneous. Optionally, denuded areas in the image which are substantially homogenous are detected. Optionally, microscopic imaging function 1 generates the grayscale image from the camera acquired image.

In some exemplary embodiments, standard deviation is used with large windowing function 2 and small windowing function 3 as a homogeneity measure. Optionally, a size of large windowing function 2 and small windowing function 3 is selected based on a size of the cell's shortest string in the culture. Optionally, a size of large windowing function 2 may be, for example 30 μm, and a size of small windowing function 5 may be, for example 10 μm, for NIH3T3 fibroblast cells.

In some exemplary embodiments, the resulting image from large windowing function 2 is input to large windowing threshold function 3, and the resulting image from small windowing function 5 is input to small windowing threshold function 6. Optionally, the resulting image from large window threshold function 3 is subject to dilation function 4 for generating an overestimation of the denuded area due to misses of real denuded areas close to edges of the denuded areas resulting from large window threshold function 3. Optionally, dilation is done with a rectangular window of a size of half the large window's size. Alternatively, other dilation techniques or windows shapes and sizes may be used. Optionally, dilation of the image from small windowing function 5 is not required since the detected denuded area is close enough to the edges of the real denuded area. Additionally or alternatively, a dilation function is used to dilate the image from small window threshold function 6.

In some exemplary embodiments, the image processed through the path of large windowing function 2 and the parallel path of small windowing function 5 are combined by image combining function 7. Optionally, processing the image through the path of large windowing function 2 detects cell concentration areas far from the edges as the large window is used. Optionally, processing the image through the path of small windowing function 3 detects cell concentration areas close to the edges but also homogenous regions inside cells. Optionally, combining the images through image combining function 7 results in a single combined image in which the cell concentration areas are detected and homogenous regions inside cells are excluded. For example, a pixel may be classified as denuded area if the corresponding pixels in images resulting from dilation function 4 and small window threshold function 6 are classified as denuded area. Alternatively a pixel may be classified as denuded area if one of the corresponding pixels in images resulting from either dilation function 4 or small window threshold function 6 is classified as denuded area. Optionally, morphological operators may be used to filter out noise and artifacts from the combined image. For example, morphological opening and closing using a rectangular structuring element, with size of the small window, may be applied. Alternatively, other types of structuring elements may be used, In some embodiments morphological opening refers to an operation of erosion followed by dilation, resulting in the removal of small isolated areas. In some embodiments, morphological closing refers to an operation of dilation followed by erosion, which results in the filling of small isolated “holes” in the image. Optionally, the combined image is reproduced by cell occupancy image reproduction function 8.

Reference is now made to FIG. 2 which is a flowchart illustration of a method for detecting cell occupancy in a cell culture, according to some exemplary embodiments of the invention. It should be evident to an ordinary person skilled in the art, that the method described may be implemented in alternative ways which may include any one of, or any combination of, changing a sequence of steps in carrying out the method, adding more steps to the method, or removing steps from the method.

At 210, a light microscopy image of the cell culture is obtained. Optionally, the light microscopy image may be a grayscale image of the cell culture.

At 220, a window function is applied to the light microscopy image. Optionally, the window function may be rectangular, although in some embodiments other window functions such as Gaussian, triangular, cosine, and the like may be applied.

At 230, image texture, which characterizes the spatial arrangement of color or intensities in an image or selected region of an image, is optionally evaluated. In some embodiments, local texture is evaluated for the windows using statistical methods for estimating pixel intensity variability within a selected window of the image. Optionally, other methods may be used for quantifying texture, such as for example, Co-occurrence matrices, local binary patterns, and laws texture energy measures.

At 240, local texture data is thresholded to identify high variability regions. Optionally, the identified high variability regions substantially correlate with the regions in the cell culture that are covered by cells. Optionally, local texture data is thresholded to identify denuded areas.

At 250, the culture confluency is automatically calculated. For example, the culture confluency may be calculated using the equation (1).

At 260, the cell count in the culture is optionally estimated by dividing the area of confluency (area covered by cells) by the average size of the cells in the culture. Optionally, the cell count is determined automatically. Optionally, the cell count is determined using a linear regression model. Alternatively, the cell count is determined using a non-linear regression model.

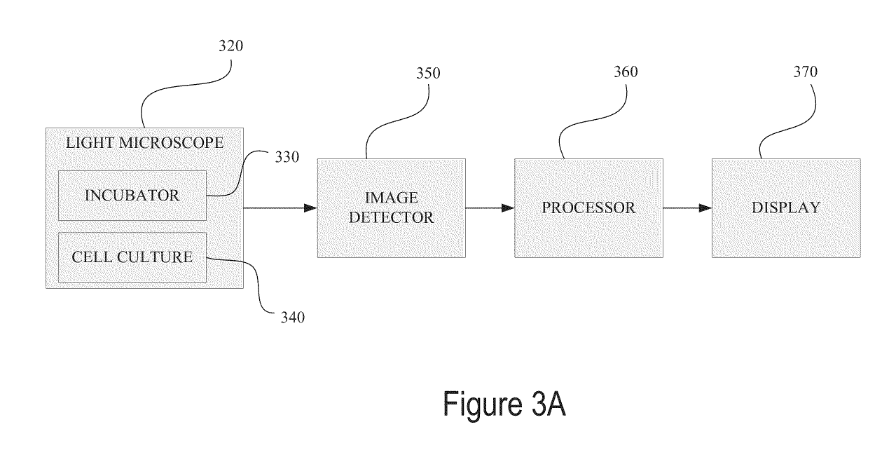

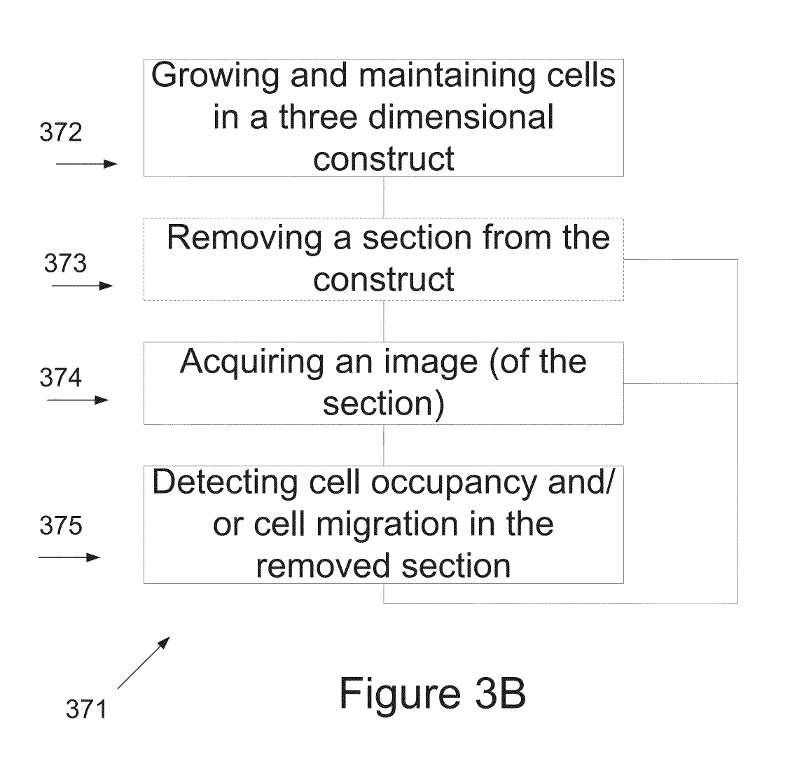

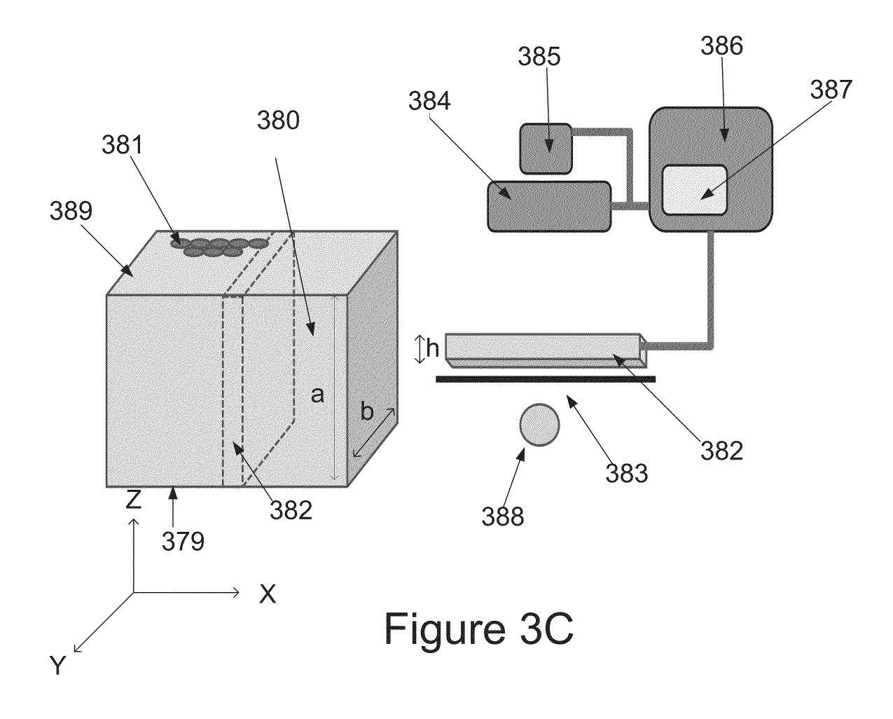

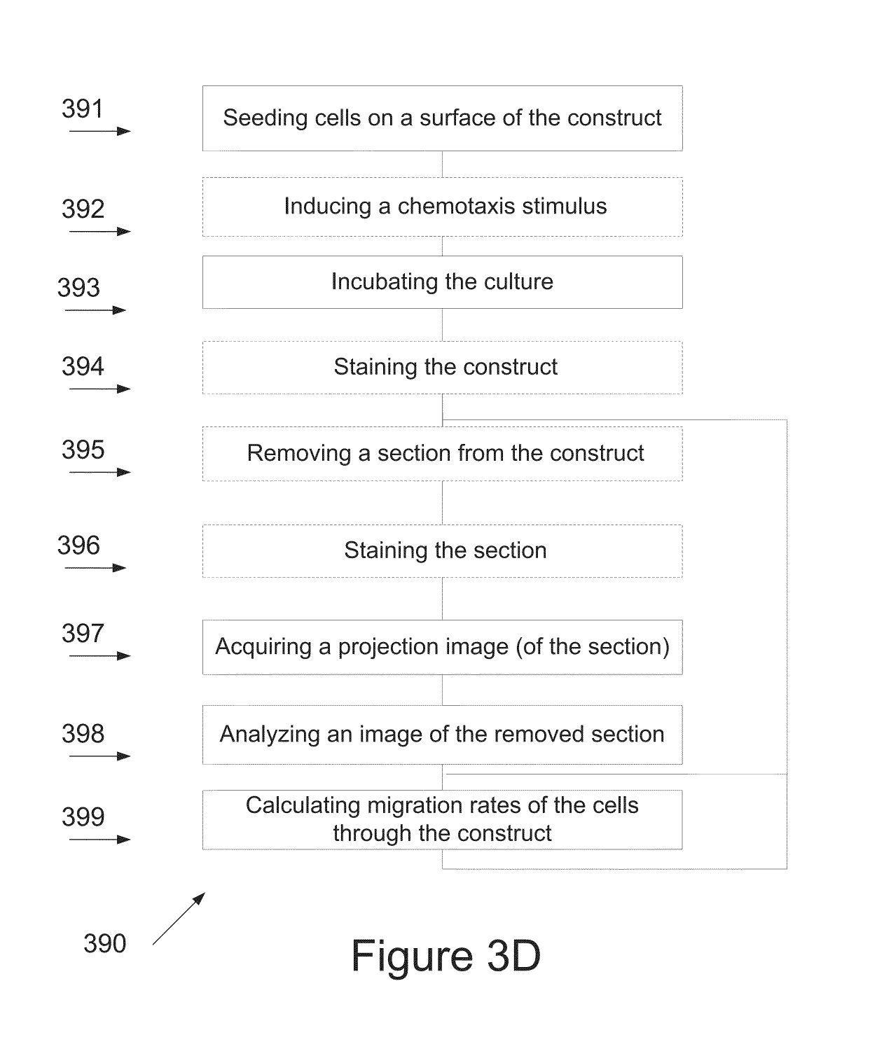

Reference is now made to FIG. 3 which schematically illustrates an exemplary system 300 for detecting cell occupancy in a cell culture 340, according to some exemplary embodiments of the invention. Optionally, system 300 includes a microscope 320 including an incubator 330 for incubating cell culture 340, an image detector 350, a device 360 (for example, a processor) for measuring cell occupancy in cell culture 340, and a display 370.

In some exemplary embodiments, cell culture 340 is a two-dimensional culture, for example including a planar layer of cells (monolayer culture). In some exemplary embodiments, cell culture 340 is a three-dimensional culture, as will be further described in FIGS. 3B,3C,3D.

In some exemplary embodiments, microscope 320 is a phase contrast microscope and includes a source of phase contrast light for illuminating a sample of cell culture 340. Optionally, microscope 320 includes applicable optics for allowing cell culture 340 to be illuminated by interior room illumination. Optionally, incubator 330 is a mini-incubator or an isolated chamber for culturing the cells. In some exemplary embodiments, image detector 350 is configured to acquire an image, for example, a grayscale image of cell culture 340. Optionally, image detector 350 includes a digital camera. Optionally, image detector 350 is a CCD camera.

In some exemplary embodiments, processor 360 is adapted to segment the acquired grayscale image and measure the cell occupancy. Optionally, processor 360 detects denuded regions therein. Optionally, processor 360 includes sufficient memory for storing at least two grayscale images of a same size of a sample of cell culture 340. In some exemplary embodiments, display 370 serves for presenting cell occupancy data and any other relevant data. Optionally, display 370 is an LCD display, a LED (light emitting diode) display, or any other type of display suitable for visually displaying the occupancy data and other relevant data.

Reference is now made to flowchart 371 of FIG. 3B, describing a general exemplary method for detecting confluency and/or cell migration in a three-dimensional construct, optionally using the device and/or method and/or system described hereinabove, in accordance with an exemplary embodiment of the invention.

A potential advantage of the three-dimensional construct is that the microenvironment of the cells better imitates in vivo conditions, for example because the entire plasma membrane of the cells interacts with its surroundings, whereas in the monolayer setting a surface of the cells contacts the culture dish. In a three-dimensional culture, cells may migrate, attach, and/or spread in multiple directions. Optionally, as a result, cell morphologies that form in a two dimensional culture may differ from those formed in a three-dimensional culture, for example cells in a two dimensional culture may have a flatter configuration. Additionally or alternatively, migration kinetics of cells in a two dimensional culture may differ from those of a three-dimensional culture, given that in a three-dimensional culture cells need to resist external forces over a larger surface area. In another example, growing and/or maintaining cells in a three-dimensional culture (as opposed to a two dimensional culture) may affect the development of lamellipodia, which is known to increase migration in a two dimensional culture, but barely appears in a three-dimensional culture. In another example, growing and/or maintaining cells in a three-dimensional culture (as opposed to a two dimensional culture) may affect the phenotype of the cells. Optionally, the three-dimensional microenvironment provides non-homogenous conditions, for example a changing density of the extracellular matrix, which may resemble in vivo conditions.

In some exemplary embodiments, cells are grown and/or maintained in a three-dimensional construct including an extracellular matrix, for example a three-dimensional hydrogel matrix, as described at 372. Optionally, the cells are arranged in a multi layered structure. Optionally, the three-dimensional construct is formed as a cubical construct, a cylindrical construct, or any other three-dimensional configuration. For example, the cell culture construct may be formed as a cuboidal hydrogel matrix, for example having a height ranging between 4-7 mm, a depth ranging between 2-4 mm, and a length ranging between 5-8 mm.

In some exemplary embodiments, a three-dimensional construct is created using a 3D printer. Optionally, a three-dimensional construct is shaped naturally or artificially. Optionally, a three dimensional construct comprises a washed sponge skeleton and/or a collagen matrix.

In some embodiments of the invention, confluency and/or migration kinetics in the three-dimensional culture are analyzed. In some exemplary embodiments, cells migrate through the construct. Optionally, cell migration in at least some portions and/or some directions in the construct is intentionally induced (for example by adding growth medium and/or other chemicals and/or biochemicals to specified locations in the construct). Additionally or alternatively, cell migration in at least some portions and/or some directions in the construct is intentionally restricted, for example using transparent rigid barriers and/or chemical gradients. Optionally, a three-dimensional construct is prepared separately from the cell culture, and the cells are seeded, for example, on a surface of the construct, or inserted into a location inside the volume of the construct.

In some exemplary embodiments, images of the three-dimensional construct are acquired, optionally using a microscope and an image detector. Optionally, if the construct comprises a transparent extracellular matrix, such as gel, projection images of the cells inside the construct are acquired.

In some embodiments, for example if the extracellular matrix is not transparent enough, a section of the construct is removed for further imaging of the section, as described at 373. Additionally or alternatively, a section is removed if the construct contains a large number of cells, because even if the cells are not dense, the projection image may include areas that appear as confluent cells when, in fact, the cells are distributed throughout the volume of the construct. Optionally, transparent components (for example rigid barriers) are used for sectioning the construct, such as to facilitate imaging a section. Optionally, if the matrix is not transparent enough, images of the external layers of the culture (such as layers that are close to the surfaces of the construct), are acquired.

The size and/or shape of the section may be selected according to a need. Optionally, the section is sized according to the original size of the construct. In some embodiments, the section is selected and/or sized according to a specific location of cells in the construct. In some embodiments, the section is selected and/or sized according to the transparency properties of the extracellular matrix. In some embodiments, the section is selected and/or sized according to a confluency measure of a section (either previously estimated or determined by the method). In some embodiments, the section is sized according to the measures of the microscope plate. Optionally, the section is selected and/or sized according to, for example, a gradient of a chemical which promotes migration that was previously introduced to the culture.

In some embodiments, the thickness of the sliced section is small enough, for example a thickness of 150 μm, such as to comprise a planar layer of cells. Optionally, the thickness of the sliced section is large enough, for example a thickness of 3 mm, such as to comprise a multilayer of cells. In other examples, the thickness of the sliced section is 100 μm, 300 μm, 0.5 mm, 4 mm, or 10 mm, 15 mm, or any intermediate and/or larger thickness.

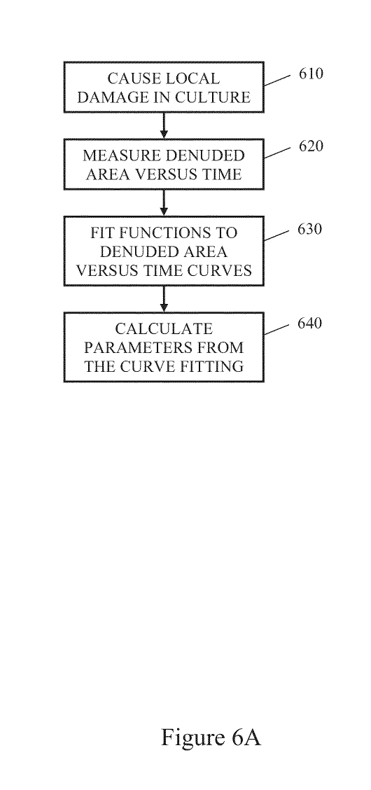

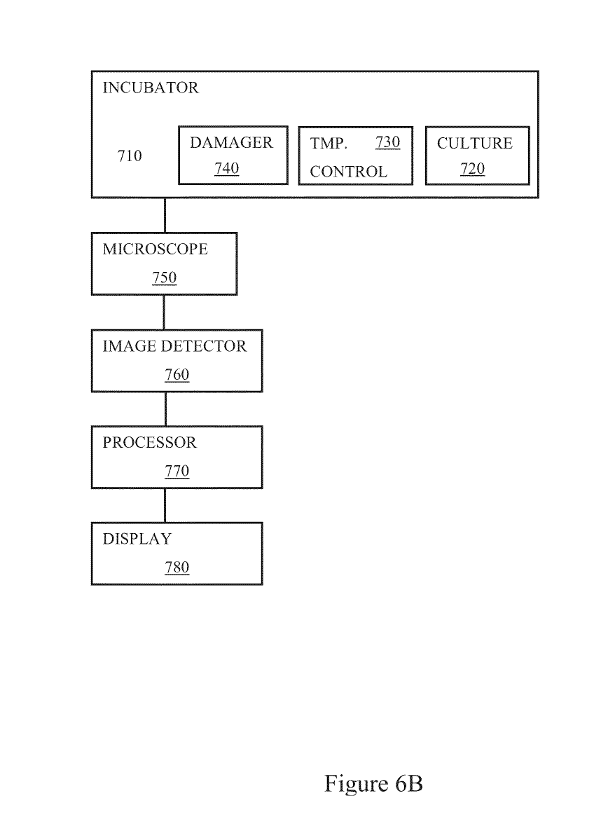

Once an image of the construct and/or section removed from the construct is acquired, as described at 374, the method described hereinabove is applied for detecting cell occupancy and/or cell migration, as shown in 375, and will be further described in FIG. 6. Optionally, the process of removing a section, acquiring an image and/or analyzing the image is repeated multiple times (373-375).

FIG. 3C shows a cuboidal three-dimensional cell culture construct 380, in accordance with an exemplary embodiment of the invention. Cells 381 may be, for example, seeded on a surface 389 of construct 380 and/or previously grown in construct 380. Optionally, growth factors and/or chemotaxis-inducing agents and/or chemotaxis inhibiting agents may be placed on surface 389, and/or on surface 379 opposite to surface 389, and/or at any other surface, and/or in a location within the volume of construct 380. Optionally, as noted above, a section 382 of the construct 380 is removed for further analysis of the section. Optionally, section 382 is a slice of the original construct 380, having a certain thickness.

In some exemplary embodiments, the cells in removed section 382 and/or construct 380 are stained, for example fluorescently stained, to be visualized under microscope 384. Optionally, staining may be useful in cases where, for example, the contrast of the image is too low, or section 382 is too thick, or if the extracellular matrix is too dark.

In some exemplary embodiments, removed section 382 is positioned on microscope plate 383 under the lens or lenses of microscope 384. In some exemplary embodiments, microscope 384 is positioned for viewing section 382 from other directions, such as below section 382. In some exemplary embodiments, light source 388 is adjusted, for example to illuminate a specific plane of section 382. In some exemplary embodiments, a very thin section, for example a relatively two dimensional section, is imaged. In some exemplary embodiments, the acquired image is a projection image of the cells located along height h of section 382 (considered as the thickness of the section). The projection image is generated as light beams originating from light source 388 are projected through section 382. According to the density and composition of the different areas of section 382, a proportion of the light is absorbed by section 382. The light that passes through section 382 is manipulated by microscope 384 and captured by image detector 385, which in turn produces a two dimensional representation of all the internal structures of section 382 superimposed on each other.

In some exemplary embodiments, microscope 384 is a stereoscopic microscope, for example enabling the adjustment of the focal plane and/or the depth of the field. Alternatively, microscope 384 may be a fluorescence microscope, enabling the visualization of fluorescently stained cells. Optionally, microscope 384 includes image detector 385 (such as a digital camera) for capturing images of section 382. Once an image of section 382 is acquired, the method described herein may be applied for detecting cell occupancy and/or cell migration.

In some exemplary embodiments, microscope 384 and/or image detector 385 rotate and/or translate relative to the section to acquire images. In some exemplary embodiments, the section itself is rotated and/or translated relative to the microscope and/or image detector. In some exemplary embodiments, a robotic device 386 optionally including a motor 387 is incorporated in the system, for example to rotate the microscope and/or the section. Optionally, multiple images of the section 382 are acquired. Optionally, images of a section and/or separate sections are further combined and reconstructed. Optionally, multiple images are processed using, for example, computed tomography methods to generate a three-dimensional image of a section and/or of the whole construct.

In some exemplary embodiments, robotic device 386 is used for selecting and/or removing a designated section from the construct 380. Optionally, robotic device 386 positions section 382 for viewing under microscope 384.

In some exemplary embodiments, physical dimensions of construct 380 along a longitudinal axis of construct 380, for example axis X, may be constant. For example, the height a and width b of construct 380 may be constant. Optionally, cells 381 are seeded evenly along axis X, for example seeded on surface 389 along axis X. Optionally, growth factors and/or chemotaxis-inducing agents may be distributed evenly along axis X. Optionally, if the described configuration is used, it may be assumed that the starting conditions (such as the number and/or location of seeded cells, and/or the amount of growth factor) remain constant along axis X.

In some embodiments, time-dependent phenomenon such as cell migration is examined. Optionally, section 382 is selected and/or imaged according to a direction in which most of the migration occurred, for example upwards a gradient of a chemotaxis-inducing agent. Optionally, section 382 is selected along a maximal gradient of a chemetaxis-inducing agent, chemotaxis-inhibiting agent, a growth factor, and/or any other chemical that was added to the culture.

In this figure, section 382 is selected parallel to the Y-Z plane. Optionally, a gradient of a chemotaxis-inducing or chemotaxis-inhibiting agent along axis Z may affect cell migration in that direction. Optionally, by selecting section 382 such that it is parallel to the Y-Z plane, cell migration along axis Z may be examined.

In an exemplary method, a plurality of sections are removed from different locations along axis X such that they are parallel to the Y-Z plane, and examined at different time intervals, such as 3 hours and 4 days after seeding, for example for detecting cell migration rates.

FIG. 3D describes a detailed exemplary method 390 for detecting cell occupancy and/or cell migration in a three-dimensional cell culture construct, in accordance with an exemplary embodiment of the invention. At 391, cells are seeded on a surface of a three-dimensional construct, such as an extracellular matrix, (for example including hydrogel). Optionally, cells are grown and/or maintained separately from the construct, and then seeded on a surface. Optionally, cells are grown and/or maintained in the construct.

In some embodiments, cells migrate through the construct. Optionally, cell migration is intentionally restricted or induced, for example chemotaxis is induced, as shown at 392, by adding additional growth medium to the culture. Optionally, chemotaxis is induced only in a specific location and/or direction in the culture. For example, chemotaxis is induced by injecting an inducing material into the volume of the culture.

Optionally, chemicals and/or biochemicals that are added to the culture affect cell migration. Optionally, mechanically introduced wounds (such as by scratching of the surface of the construct) and/or internal wounds (such as created by a needle inserted to the volume of the construct) affect the cell migration.

In some embodiments, as shown at 393, the cell culture is incubated for a period of time, for example 3 hours, 1 day, 5 days.

In order to acquire images from the three-dimensional construct, a section of the construct is optionally removed, as shown at 395, for example a cuboidal section comprising a thickness of 2 mm. Optionally, for example if the culture is made of a transparent substance, projection images of the cells are acquired (eliminating the need to remove a section).

In some exemplary embodiments, the whole construct and/or the removed section are stained, as shown at 394 and 396, for example fluorescently stained (for example with 4′,6-diamidino-2-phenylindole), to allow visualization of the cell nuclei using a fluorescent microscope.

A projection image of the removed section and/or whole construct is acquired using a microscope and/or an image detector, as shown at 397, and analyzed (398) for example using the image analysis method described herein. Optionally, confluency of the cells is detected. Optionally, images are acquired at a plurality of times. Optionally, the migration distance of the cells through the construct is determined for each time point, for example by calculating the ratio of the cell-populated area over, for example, the total area of the construct.

Optionally, the migration rate of cells migrating through the construct is calculated, as shown at 399, for example by acquiring images at a plurality of times, (optionally being images of the same section), or of different sections having similar characteristics as described hereinabove), and calculating the ratio of the difference in calculated cell migration distance between, for example, two time points, divided by the time interval between them.

In some embodiments, the methods and/or combinations thereof described in the above FIGS. 3B-3D are used for two dimensional cultures as well as three-dimensional cultures. Other embodiments described throughout the application may include the methods described above.

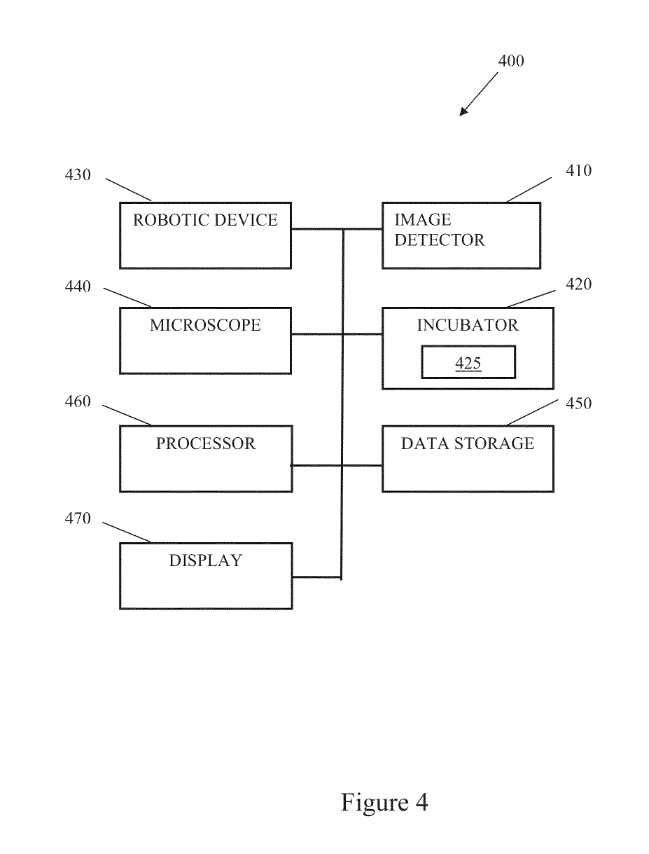

Reference is made to FIG. 4 which schematically illustrates a block diagram of an exemplary automatic cell culturing system 400, according to some embodiments of the present invention. Automatic cell culturing system 400 may include one or more robotic devices 430 adapted to perform cell passaging and/or cell differentiation. Optionally, robotic device 430 moves cell cultures under a microscope 440 for viewing of the cell cultures. Optionally, an image detector 410 is used for acquiring one or more images of the cell culture. Optionally a plurality of images is acquired over a period of time.

In some exemplary embodiments, a processor 460 processes the acquired image for automatically determining confluency in the cell culture using the methods for determining cell confluency described herein. For example, processor 460 may determine confluency in the cell culture using the method for detecting cell occupancy in a cell culture as described with reference to FIG. 2. Additionally, a degree of confluency is determined. Additionally or alternatively, processor 460 is used for measuring the kinematics of the cell culture. Additionally or alternatively, processor 460 is used for measuring sperm motility. In some exemplary embodiments, processor 460 is used for determining the average migration distance of the cells in a three-dimensional cell culture, for example by calculating the ratio of a cell populated area over the total height of the construct. Optionally, processor 460 is used for determining confluency in a three-dimensional cell culture, for example confluency detected at a projection image of the surface of a section of the construct. Additionally or alternatively, processor 460 is used for determining cell migration rates in a three-dimensional cell culture, using data acquired at various time points. Additionally or alternatively, processor 460 may initiate various processes related to growing and maintaining the cell culture, such as cell passaging or cell differentiation, based on the determined confluency in the cell culture. For example, processor 460 may activate robotic device 430 to perform the processes related to growing and maintaining the cell culture. In some embodiments, automatic cell culturing system 400 includes an incubator 420 sustaining a call culture 425 under controlled environmental conditions such as temperature, humidity and PH level. System 400 may be used, for example, but not limited to studying the mitosis, death, growth, response to ischemic factors, of the cells in cell culture 425. System 400 may include a display 470 for displaying various parameters such as cell confluency of cell culture 425, and input means such as a keyboard and a mouse, as known in the art (not shown).

In some exemplary embodiments, automatic cell culturing system 400 is used for remote monitoring of the cell culture from a distant location. Optionally, remote monitoring is done by a researcher at the remote location. Additionally or alternatively, the monitoring is done automatically at the remote location. In some embodiments, the remote monitoring includes use of one more robotic devices 430 and/or microscopes 440. Optionally, acquired data, including detected images, are stored in a data storage unit 450.

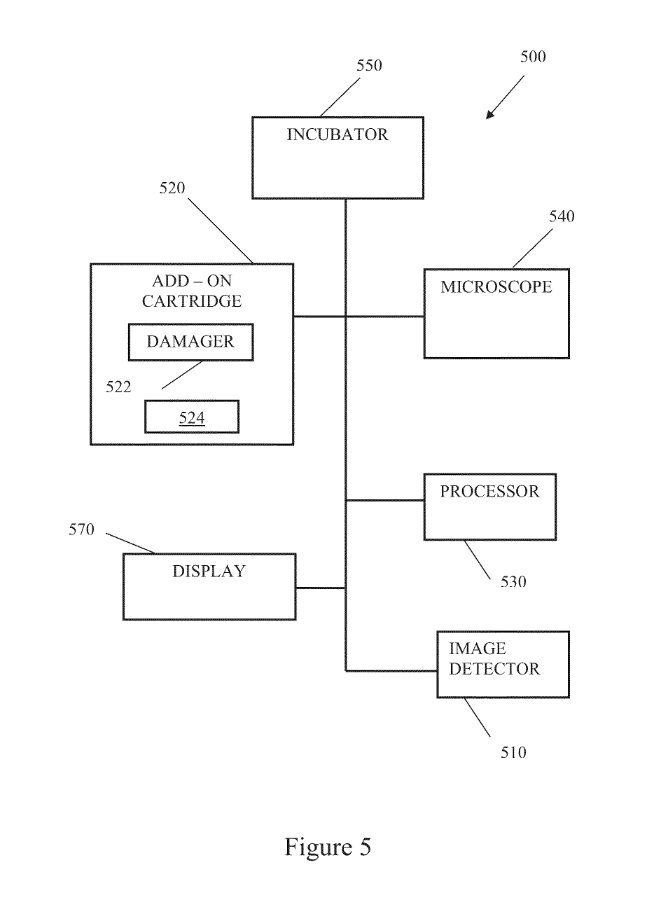

Reference is made to FIG. 5, which schematically illustrates a block diagram of an exemplary system 500 for automatically determining cell confluency, according to some embodiments of the present invention. System 500 may include an add-on cartridge 520. Add-on cartridge 520 may accommodate cell culture 524 and may include a damager 522. Damager 522 may be a device capable of causing micro damage to cell culture 524. For example, damager 522 may include a micro-indenter a micro-scratcher or a micro heater etc. Add-on cartridge 520 may be placed within incubator 550 for incubating cell culture 522 and sustaining cell culture 524 under controlled environmental conditions such as temperature, humidity and PH level, for example, after casing injury to cell culture 524 using damager 522. Additionally or alternatively, add-on cartridge 520 may be placed under microscope 540 such that cell culture 534 may be viewed. Microscope 540 may be a phase contrast microscope. In some exemplary embodiments, image detector 510 is configured to acquire an image, for example, a grayscale image of cell culture 524. Processor 530 may be adapted to measure cell confluency using methods for determining cell confluency described herein. For example, processor 530 may determine confluency in the cell culture using the method for detecting cell occupancy in a cell culture as described with reference to FIG. 2. System 500 may include a display 570 for displaying various parameters such as cell confluency of cell culture 524, and input means such as a keyboard and a mouse, as known in the art (not shown).

Optionally, incubator 550 may be a mini-incubator or an isolated chamber for culturing the cells, adapted to accommodate add-on cartridge 520. Thus incubator 550 may be placed together with add-on cartridge 520 under microscope 540. Alternatively, incubator 550 may be a large incubator, large enough to accommodate add-on cartridge 520 as well as microscope 540. In any configuration, add-on cartridge 520 and microscope 540 may be designed so that cell culture 524 will be placed under microscope 540 for viewing and acquiring images by image detector 510. In some exemplary embodiments, in which the sample is a three-dimensional cell culture, a section is optionally extracted from the three-dimensional construct. The section is placed under microscope 540 for viewing and acquiring images by image detector 510. In some exemplary embodiments, the whole construct is viewed under the microscope.

In some embodiments, an add-on cartridge is used for providing cell confluency measurement ability and may be provided, for example, with an electrical connector for data connection to the microscope or with an optical connection to receive an optical image (e.g., and sample it). Optionally or alternatively, the cartridge is a software module which is downloaded to an image processing computer, for example, a simple application or “app”. In an exemplary embodiment of the invention, such a cartridge or app may include billing tools, for example, being activatable only for a limited amount of, for example, time, cultures and/or reuses. In an alternative embodiment, confluency is estimated at a remote server which receives data from the microscope.

Reference is made to FIG. 6A which illustrates an exemplary method for measuring cell migration in a cell culture, according to an embodiment of the present invention.

At 610, a wound is created in the cell culture, for example, by causing controlled micro damages in the cell culture. The wound may be mechanically induced, thermally induced, chemically induced, or electrically induced, or any combination thereof. Optionally, the wound may be automatically induced and/or manually induced.

At 620, a sequence of images of the area of the wound are obtained over a period of time. Various parameters, descriptive of the condition of the wound over time may be determined using embodiments of the present invention. For example, cell confluency, size of the denuded area, cell count may determined in the wound area in each image. Optionally, these parameters may be determined using an embodiment of the method disclosed herein. Additionally or alternatively, pixel intensities are measured and texture is analyzed for determining cell denuded areas and cell populated areas in each image. Optionally, the denuded areas are the wound areas. In some embodiments, the microscope is moved over the culture or the culture is moved under the microscope.

Each determination of parameters listed hereinabove represents a data point. A minimum of two data points may be required, for example, 3, 5, 10, 50, 100, 500, 1000, or more data points may be obtained. Optionally, the maximum number of data points is limited by the sampling rate of the microscope, the length of the time period, and the data storage capacity. Data points may be plotted against time.

At 630 functions may be fitted to the curves of data points vs. time using known in the art curve fitting algorithms. For example, a function may be fitted to the denuded area vs. time curve. Alternatively, a function may be fitted to the confluency vs. time curve, etc. Optionally, a particular family of the generalized (asymmetric) logistic functions may used for curve-fitting. Optionally, the function used for curve-fitting is a Richard's function.

At 640, following the curve-fitting, parameters descriptive of the healing process are calculated. These may include, for example, a cell migration rate, a time for onset of mass cell migration (TOMCM), a time for end of mass cell migration (TEMCM). In some embodiments, the calculated parameters may be used in research work, or for evaluating a patient, for example, for seeing what happens and/or what treatment region is most effective and/or predict healing time.

Reference is made to FIG. 6B which schematically illustrates an exemplary system 700 for continuously measuring kinematics in a cell culture 720, according to some exemplary embodiments of the invention. Optionally, system 700 for measuring of cell kinematic includes circuitry for carrying out the method previously described and shown in FIG. 6A. System 700 optionally includes an incubator 710 for incubating cell culture 720, a temperature controller 730 for controlling an ambient temperature to which the cell culture is exposed (temperature inside the incubator), and/or a damager 740 for creating a wound in the cell culture. Optionally, incubator 710 is a mini-incubator or an isolated chamber for culturing the cells that may be placed under microscope 750. Alternatively, incubator 710 is a large incubator capable of accommodating microscope 750 as well as image detector 760. In some embodiments, system 700 optionally includes an image detector 760, a device 770 (for example, a processor) for measuring cell occupancy in cell culture 720, and a display 780.

In some exemplary embodiments, damager 740 may be any type of device capable of causing controlled micro damages to the cell culture. The damager may be either a mechanical micro-indenter or a micro-scratcher. Additionally or alternatively, damager 740 may be any device known in the art suitable for causing a controlled chemical, electrical or a thermal micro damage.

In some exemplary embodiments, microscope 750 is a phase contrast microscope and optionally includes a source of phase contrast light for illuminating a sample of cell culture 720. Optionally, microscope 750 includes applicable optics for allowing cell culture 720 to be illuminated by interior room illumination.

In some exemplary embodiments, image detector 760 is configured to acquire a sequence of images over an interval of time of cell culture 720. Optionally, image detector 760 includes a digital camera. Optionally, image detector 760 is a CCD camera or a CMOS camera.

In some exemplary embodiments, processor 770 is adapted to automatically calculate the parameters of the kinematics of cell culture 720 by, for example, wholly or partially implementing steps 620-640 in the method previously described and shown in FIG. 6A.

In some exemplary embodiments, display 780 serves for presenting cell kinematic data and any other relevant data. Optionally, display 780 is an LCD display, a LED (light emitting diode) display, or any other type of display suitable for visually displaying the occupancy data and other relevant data. In some embodiments, data associated with determining of cell motility, or results of such measurements are displayed.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion. It should be noted that the techniques described in the examples may be modified, for example, as described above and the inclusion of multiple acts or specific parameters in a particular examples do not preclude an embodiment of the invention form omitting or changing and act or a parameter.

### A. Detailed Description of Experiment for Measuring Confluency

The inventors conducted experiments to evaluate the performance of an embodiment of a disclosed method of determining cell occupancy. Specifically, the growth of three cell types NIH3T3 fibroblasts, C2C12 myoblasts and 3T3L1 pre-adipocytes was monitored over five days, from low to high confluency. Each of these cell types had different morphology and distinct visual appearance under a microscope.

### Description of an Embodiment of a Method Used for Confluency Measurements

In accordance with some embodiments of the present invention, the method detected denuded areas in a micrograph of a culture based on standard deviation (SD) of pixel intensities, where low SD values indicate absence of cells and high SD values correspond to areas populated by cells. The ratio of the accumulative area populated by cells over the total area of the field of view (FOV) of the microscope is used to determine the confluency of the culture. A standard phase contrast lab microscope having standard microscope lighting, a digital camera and a PC were used. No chemical stains were involved and therefore, the measurement of confluency was direct, unbiased and did not interfere with the growth of the culture. The calculation of confluency took only about half-a-second for images with a size of 854×640 pixels on a normal desktop PC (Pentium Dual-Core 2.13 GHz).

Denuded Area Detection Algorithm

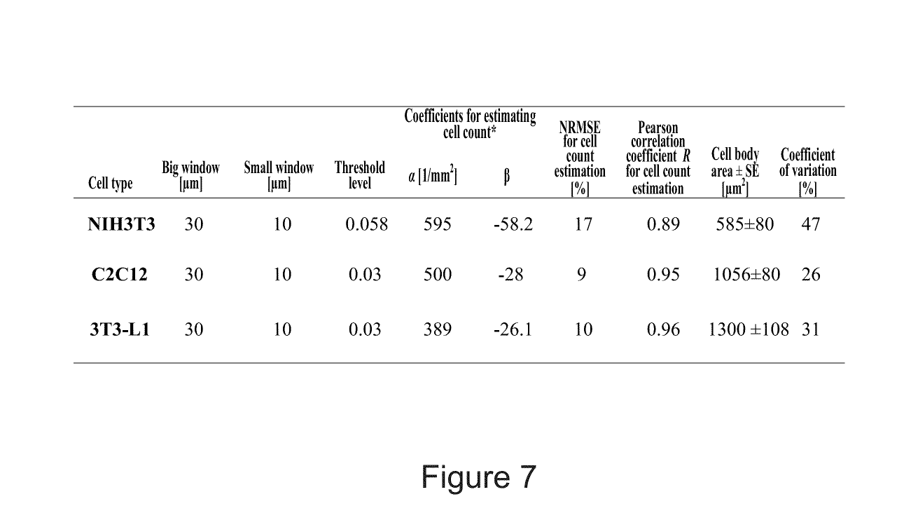

The method was applied to each image in order to evaluate confluency, using the parameters specified in the table in FIG. 7 for calibrating the process for each cell type, and three images from different field-of-views (FOV) per each time sample were averaged to obtain the mean confluency at a time point. Confluency was calculated from each output image using equation (1).

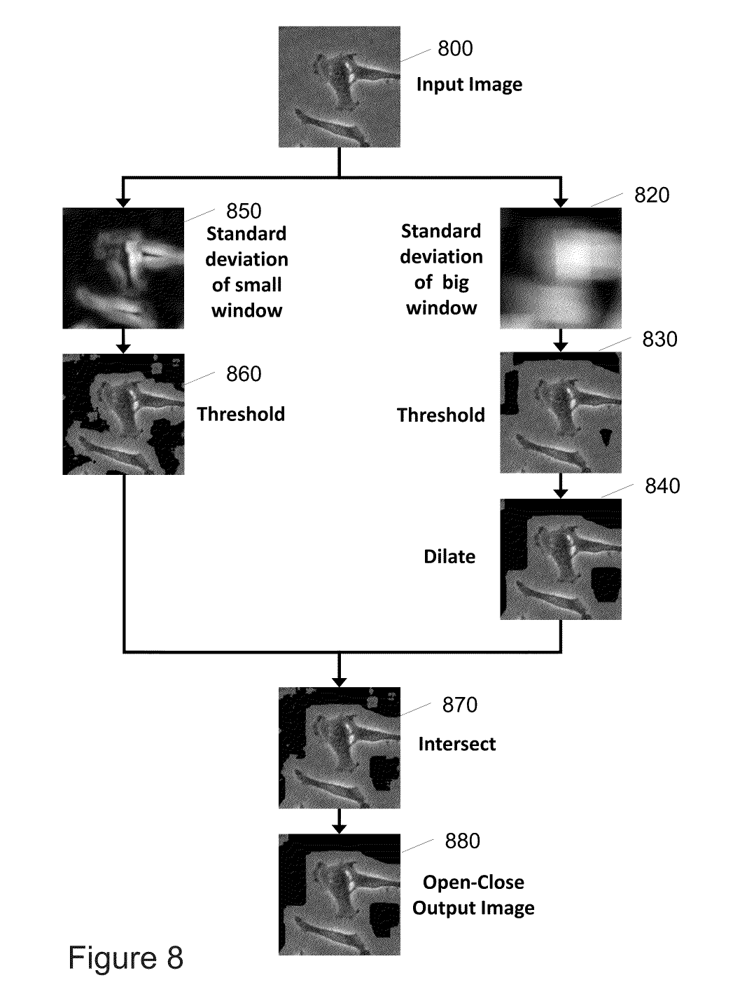

Reference is now made to FIG. 8 which is an exemplary demonstration of a method for cell confluency measurement, using a simplified “micrograph” containing just two cells, according to embodiments of the present invention. Confluency was calculated as the ratio of the area populated by cells over the total area of the FOV. The FOV may be of any size, for example, it may be as small as the size of a cell, or larger depending on the area of the culture being imaged, for example 800μ×600μ, although none of these size examples are limiting. The method segmented a micrograph 800 into two areas, area populated by cells versus denuded area. This segmentation is based on image texture homogeneity where areas populated by cells are characterized by a more inhomogeneous texture as opposed to denuded areas which tend to have a more homogenous texture. Texture homogeneity is quantified using SD of pixel intensities in a grayscale micrograph 800 (“input image”) over a window around every pixel of the image. Two window sizes are used per each image: “big” window and “small” window, to achieve SD arrays 820 and 850 of coarse and fine homogeneity measures, respectively. SD arrays 820 and 850 are grayscale images in which black represent substantially homogenous texture, and lighter shades represent inhomogeneous texture. A threshold filter is then applied on the resulting two SD arrays 820 and 850 to distinguish between areas populated by cells and denuded areas. The threshold value is determined empirically, once for each cell type, and later can be used for all micrographs of the same cell type. Moreover, the same threshold value is used for classifying cell-populated or denuded areas where analyzing the SD arrays associated with the big 820 and small 850 windows. Threshold values are pre-determined for a given cell type in a calibration process through iterative visual inspection of detected denuded areas in the final output image and adjustment of the threshold level, which is being increased if the denuded areas are smaller than desired, or decreased otherwise. Optionally, calibration may be done through a calibration section in the culture or in the image with a known confluency.

After applying the threshold filter, the arrays associated with the big 820 and small 850 windows are both reduced to binary arrays 830 and 860, where “1”, presented in binary arrays 830 and 860 as black pixels, denotes a point (pixel) in a denuded area, and “0”, presented in binary arrays 830 and 860 as the original pixels of micrograph 800, indicates the body of a cell. Detected denuded areas in the binary array 830 resulting from the big window are typically too far from the actual cell boundaries. In order to correct for this bias the binary array 830 of the big window is morphologically dilated using a rectangular structuring element with size of half of the big window, so that detected denuded areas will become closer to cells boundaries, as seen in dilated array 840. Optionally, the dilation operation uses a structuring element for probing and expand the shapes contained in the input image. In some embodiments the structuring element may have a non-rectangular shape, for example, circular or elliptical. The denuded areas in arrays 860 and 840 resulting from the big and small windows are then intersected, as seen in array 870. e.g. a pixel is classified as denuded area if the corresponding pixels in both small threshold image 860 and dilated array 840 are classified as denuded area. Finally, morphological opening and closing using a rectangular structuring element, with size of the small window, are applied. Specifically, morphological opening is the operation of erosion followed by dilation, resulting in the removal of small isolated areas. Morphological closing is the operation of dilation followed by erosion, which results in the filling of small isolated “holes” in the image. The outcome is the output binary image of segmented denuded areas 880 (“output image”) (FIG. 9).

Cell Cultures

The cell cultures include C2C12 murine myoblasts, 3T3-L1 murine embryonic fibroblasts and NIH3T3 fibroblasts, which are cell types typically deep wounds. Cells of each type were maintained in growth medium (GM) composed of Dulbecco's modified Eagle's medium (DMEM) supplemented with 10% Fetal Bovine Serum (FBS), 2 mM Glutamine, 0.1 μg/ml penicillin, and 0.1 μg/ml streptomycin (all materials of the GM were purchased from Biological Industries, Israel). For each cell type, vials containing 1×10⁶ cells were first thawed from storage in liquid nitrogen and cultured in 25 cm² flasks for 3 days in an incubator at 37° C. and 5% CO₂. Cells were passaged by washing them twice with PBS, applying 1 ml Trypsin-EDTA solution (0.25%/0.05%) for 5 minutes, adding GM, centrifuging with 300 g for 7 minutes and removing the supernatant. After the first passage, cells were grown in 75 cm² flasks. The medium was changed every 3-4 days. Cells were then passaged after 3-4 days and cultured in 35 mm petri dishes (the total area of a culture dish was 9.6 cm²), in duplicates and with 5×10⁴ cells per dish. These cultures were monitored for confluency for five days, twice a day, and three images were captured from different FOV per each culture and at each time point.

The calculation performed by the algorithm determines confluency of a given micrograph, i.e. a single FOV. However, cell occupancy at a certain time point may vary across different culture regions as explained with reference to FIG. 9 To account for this variability in cell densities over the surface of the culture dish in the experimental design, aimed at testing the performances of the present algorithm, an embodiment of the method was applied to three different FOVs and confluency was averaged across the three FOVs per each culture dish and time point. Such a design mimics the typical testing of confluency by an expert biologist, who would normally visually examine several FOVs at the same culture before determining its confluency. Optionally, a greater number of FOVs may be measured, for example, 2, 5, 10, 50, or more. Additionally or alternatively, the FOVs may be repeated or randomly positioned.

Acquisition and Processing of Micrographs

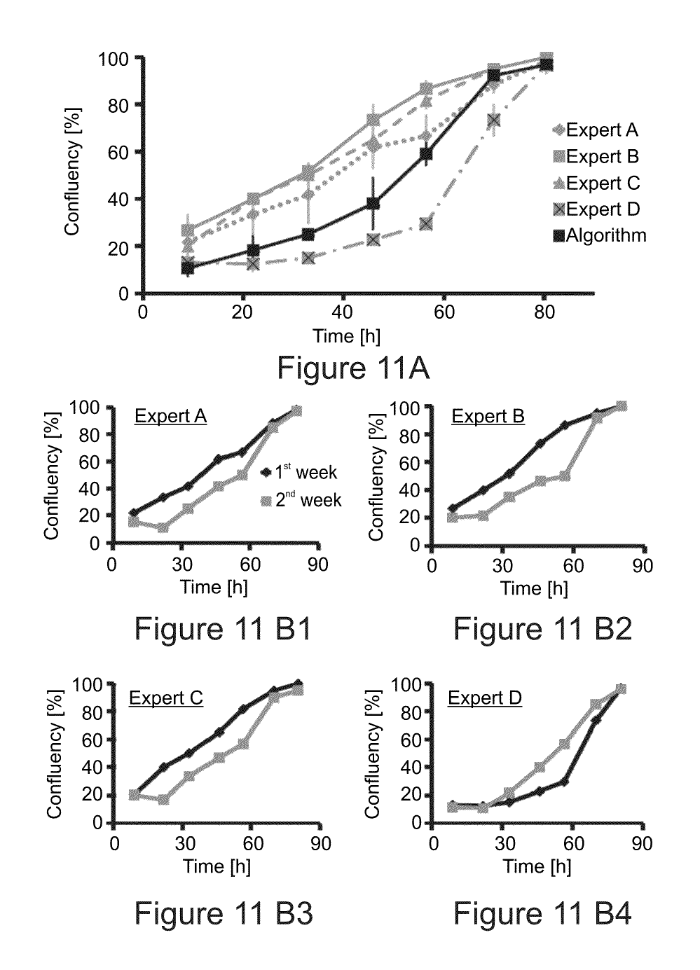

Culture images were photographed using a digital camera (DS-Fil, Nikon) connected to an optical microscope (Eclipse TS100, Nikon) set to the x10 objective. The resolution of all captured micrographs was 2560×1920 (3 pixels per micron) and the digital FOV of the camera was 850×640 μm. Image processing, as described with reference to. FIG. 11 was implemented using MATLAB (MathWorks). For faster processing, images were downscaled to a third of their original size, i.e. to 854×640. The histograms of each downscaled image were linearly adjusted to cover the entire grayscale spectrum. The algorithm was then applied to each image in order to evaluate confluency, using the parameters specified in FIG. 7 for each cell type, and three images from different FOV per each time sample were averaged to obtain the mean confluency at a time point. Confluency was calculated from each “output image” using equation (1). For verifying the results of the confluency measurements, all images were visually inspected for correctness of segmentation of denuded areas. In addition, in order to obtain quantitative measures of accuracy, cell counts were further estimated based on the area populated by cells, as detected by our method. It was assumed that the cell count can be approximated by equation (3). The accuracy was evaluated using the normalized root mean square error (NRMSE) per equation (4).

Comparisons of Algorithm Performance to Human Observations

The method was tested with 12 (different) micrographs of C2C12 cells, all identified as being 100% confluent by expert biologists experienced with cell culturing work. The confluency calculations obtained using the method were consistently over 99% for all these micrographs. Studies were performed involving four expert biologists who were asked to visually assess the time course of confluency of an NIH3T3 culture through over the entire confluency range, based on a time-series of micrographs. The expert evaluation procedure was repeated with the same subjects a week afterwards, to look at intra-subject variability in assessments. The present algorithm was applied to the same dataset of micrographs used by the experts, and the time course of confluency data calculated by the algorithm and evaluated by the human experts were graphically superimposed for comparisons.

### Results

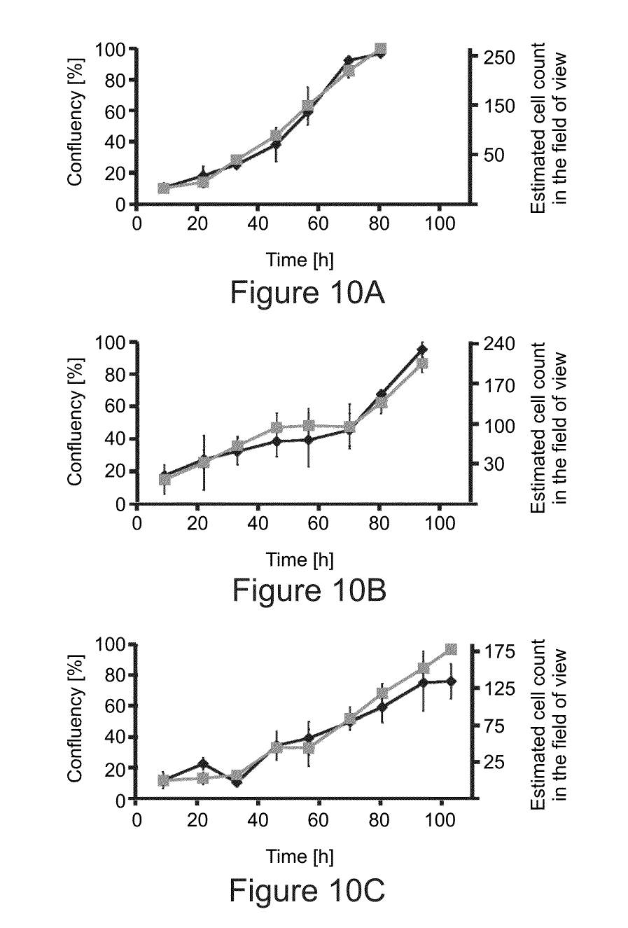

Visual examples of confluency measurements using the algorithm, according to some embodiments of the present invention, are shown in FIG. 9 and time plots of confluency are provided in FIG. 10. The algorithm depicted the time course of confluency as being in the midrange of the expert evaluations (FIG. 11a). Intra-observer differences varied by as much as 20-30% around the intermediate culture periods when allowing a week in-between evaluations (FIG. 11a).

Time plots for all cultures showed a sloping to over 90% confluency within the 5 days period, excluding one of the 3T3-L1 cultures (FIG. 10). Despite that each “input image” had different brightness and that some images were unevenly illuminated, the detection process was insensitive to these variations, as evident in the visual inspection of all “output images” (FIG. 9).

NIH3T3 culture images overall showed higher contrast between the cells and background with respect to the C2C12 and 3T3-L1 culture images, which imposed lower threshold levels for the two latter cell types (FIG. 7). The C2C12 and 3T3-L1 culture images contained a few cells with weak appearance of boundaries and nearly transparent cell body, which resulted in that approximately 5% of the cells belonging to these cultures were omitted from the output image produced by the algorithm, as detected by visual comparisons with the corresponding input images. This hardly influenced the confluency measurements (by no more than 5%). Lowering the threshold levels for the C2C12 and 3T3L1 culture images with respect to the images of the NIH3T3 cultures (FIG. 7) minimized the effects of weaker visual imprints of C2C12 and 3T3-L1 cells on the evaluated confluencies.

Confluency versus time plots for the same cell type are overall similar, e.g. steeper for NIH3T3, and show a moderation for the midrange times for C2C12. However the method demonstrates marked variability in growth rates across cell types (FIG. 10).

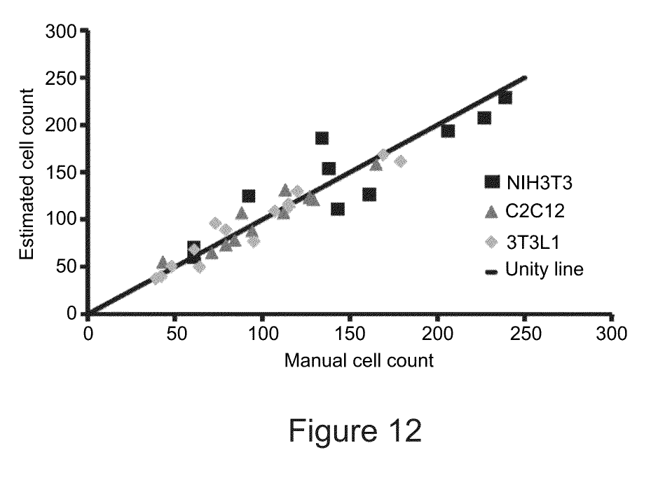

Estimated cell counts plotted versus manual cell counts (FIG. 12) overall demonstrated low scattering around the unity line, with less scattering for the C2C12 and 3T3-L1 cultures and more scattering for the NIH3T3 cultures. This variation is also reflected in NRMSE (FIG. 7) where cell counts in the C2C12 and 3T3-L1 cultures could be estimated with an accuracy of ˜10% with respect to manual counts. This accuracy was reduced to ˜17% in the NIH3T3 cultures, likely because cell sizes were more variable in this cell type (see coefficient of variation data in FIG. 7 and visual examples in FIG. 9).

### B. Detailed Description of Experiment for Continuously Measuring the Kinematics of Cultures Covering a Mechanically-Damaged Site

The inventors conducted experiments to evaluate the performance of an embodiment of a method of measuring cell migration.

### Description of an Embodiment of a Method Used for Measuring Cell Migration

An automatic and quantitative method for determining time-dependent damage areas in “wound healing” monolayer culture experiments by means of image processing was used. “Wound” area over time data were fitted to a Richards function (non-symmetric sigmoid) from which were determined the migration rate, time for onset of mass cell migration defined as the time when 10% of the wound area was covered, and time for end of mass cell migration, defined as the time when 95% of the wound area was covered. The “wound healing” experiments were conducted in 8 cultures of NIH3T3 fibroblast cells which were monitored by time-lapse microscopy. The measurements derived from the Richards function fits to the area-time curves (normalized root mean squared errors 3.8%) were calculated based on the entire time course of the data.

### Cell Culturing and Infliction of Damage

NIH3T3 cells were maintained in a growth medium (GM) composed of Dulbecco's modified Eagle's medium (DMEM) supplemented with 10% fetal bovine serum (FBS), 2 mM Glutamine, 0.1 μg/ml penicillin, and 0.1 μg/ml streptomycin. Cells were first thawed from liquid nitrogen storage and cultured in 25 cm² flasks for 3 days in an incubator at 37° C. and 5% CO₂. Cells were then passaged by washing twice with PBS, applying 1 ml Trypsin-EDTA (0.25%/0.25%) for 2 minutes, adding 2 ml of GM, centrifuging with 300 g for 7 minutes and removing the supernatant. After the first passage, cells were cultured in 75 cm² flasks. Cells were continuously passaged every 3-4 days and cultured in 75 cm² flasks, and then in 35 mm Petri dishes in preparation for the migration studies. Cells in 35 mm petri dishes were cultured for 2-3 days until reaching confluency. Cells at localized sites in these confluent cultures were mechanically crushed using a metallic micro-indenter (size ˜420 μm) which applied a quasi-static load to create an approximately circular “wound” (having a size similar to that of a needle puncture).

### Time-Lapse Microscopy to Monitor Cell Migration

Cell migration in 8 different “wound” assays conducted as described above, were monitored using time-lapse microscopy. The temperature and pH of cultures were both controlled. Specifically, the temperature of the medium was maintained at 37° C. using a heater mat (model 245-635, RS Components Co.) as a heat source, and a thermocouple (621-2164, RS Components Co.) for temperature measurements; both devices were connected to a temperature controller PXR4 (Fuji, 539-5101 RS Components Co.). The pH was kept nearly constant at a level of 7.6 by adding 55 mM of HEPES to the GM of the monitored cultures. The cultures were isolated from the environment while being monitored under the microscope, using a plastic hood. Optionally, other environmental control methods may be used.

Culture micrographs were automatically photographed at 1-minute intervals (using custom-made software) by means of a digital camera (DS-Fil, Nikon) connected to an optical microscope (Eclipse TS 100, Nikon) which was set to the x10 objective. The resolution of the captured micrographs was 2560×1920 (3 pixels per micron). Micrographs were captured until complete coverage of the “wound” was observed, which took about a day (see Results).

### Data Analysis

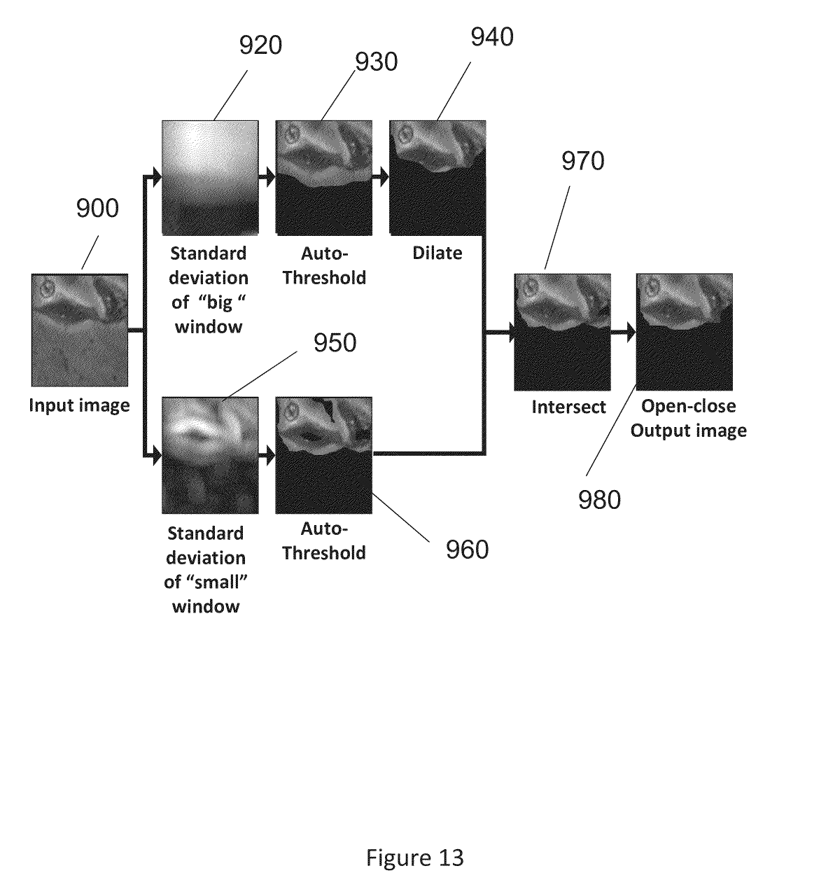

The area of the “wounds” was quantified automatically by applying a custom-made micrograph image processing code (FIG. 13) which segments each analyzed micrograph 900 (at each time point in the sequence) into two regions: the “wound” region, versus a cell-populated surrounding region. This segmentation is done based on local image texture properties. Specifically, the wound region is characterized by a more homogeneous image texture as opposed to the cell-populated region which is characterized by a more inhomogeneous texture. Standard deviation (SD) of pixel intensities over a square “window” of pixels in the micrograph is used as the local texture homogeneity measure for the location of the center of the window, where a low SD value represents a locally-homogeneous image texture and a high SD value represents a locally-inhomogeneous texture. To characterize texture homogeneity over the entire micrograph 900, the SD of pixel intensities is calculated for a moving window that runs through each pixel over the micrograph, which eventually results in an SD map of the micrograph. Alternatively to SD, other variability functions may be used of either a first order or a second order. This SD map is hence a map of texture homogeneities in the micrograph 900. Thresholding 930 and 960 is then applied on the SD map to segment the micrograph into the wound versus cell-populated regions. The threshold level for this segmentation is determined as half the highest local maximum of pixel intensities in the histogram of the micrograph (which empirically showed good segmentation performances).

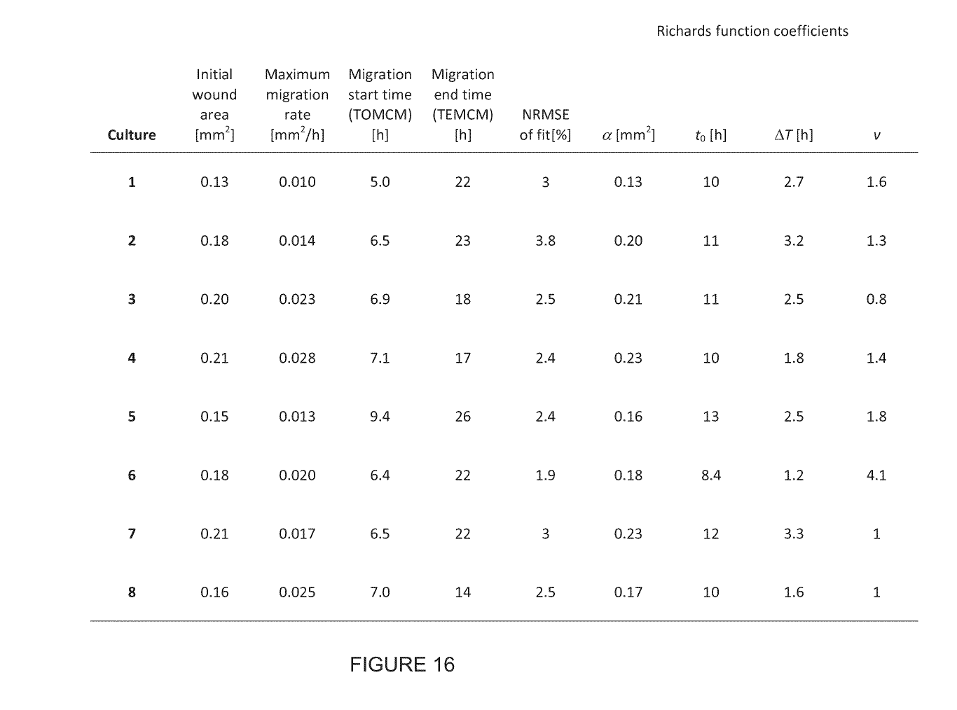

The segmentation process described above is done twice: first using a “big” window 920 (with size of 30 μm) and second, using a “small” window size 950 (10 μm). The use of the two window sizes together provides better robustness of the final segmentation outcome (FIG. 16). A pixel is classified as being within the “wound” area only if both pixels at the corresponding locations from the big 920 and small 950 window processing are classified as “wound” pixels. Lastly, “noisy” areas, if existing, are filtered from the intersected image 970 by morphologically “opening and closing” with a rectangular structuring element 940 having the size of the small window (10 μm) (FIG. 13). This provides the final “output image” 970 (FIG. 13). An exemplary embodiment of the algorithm (FIG. 13) was tested using hundreds of micrographs of 3T3 cells which were checked visually and processed automatically.

The above image processing algorithm was applied to each individual micrograph 900 along the time sequence of every experiment, to ultimately produce a “wound” area (A) over time (t) plot per each experiment. The A-t plots were filtered using a moving average (MA) low-pass filter with a window size of 11 equally-weighted time points in order to further reduce measurement noises. Alternatively, other low pass filtering methods may be used to reduce measurement noise, as known in the art. The A-t plots were then fitted to a Richards (non-symmetrical sigmoid) function given by equation (6),

$$A ( t ) = \frac{α}{{( 1 + v {e}^{\frac{t - {t}_{0}}{Δ T}} )}^{\frac{1}{v}}} \qquad ( 6 )$$

where α, ν, t₀ and ΔT are the coefficients obtained from minimizing an objective function of the sum of squared errors between the experimental A-t plot and fitted Richards function. Fitting the Richards functions and deriving the coefficients was performed using Matlab, Mathworks code. The maximum cell migration rate, Max (dA/dt), which is the maximum slope of the fitted Richards function, can be evaluated using the aforementioned parameters, by equation (7):

$$\vert Max Slope \vert = \frac{α}{Δ {T ( 1 + v )}^{\frac{1 + v}{v}}} \qquad ( 7 )$$

The time when a specific portion of the wound area has been covered by cells is given by equation (8):

$${t}_{p} = {t}_{0} + Δ T ln ( \frac{{α}^{v} - {{a}_{0}^{v} ( 1 - p )}^{v}}{{{va}_{0}^{v} ( 1 - p )}^{v}} ) \qquad ( 8 )$$

where p is the normalized extent of coverage ranging from 0 (none) to 1 (full) and a₀ is the initial wound area.

The kinematic parameters of NIH3T3 cultures (MaxSlope, and times for covering 10% and 95% of the wound area) for cultures kept in a standard incubator at standard storage conditions (temperature of 37° C., relative humidity of 95% and 5% CO₂) from preliminary studies were compared against corresponding data acquired in the experimental setup. No statistically significant differences were found.

The outcome measures obtained from the A-t plots were the: (i) Maximum migration rate in mm² (eq. 7), (ii) Time of onset of mass cell migration (TOMCM) which was defined as the time when 10% of the wound area was covered (eq. 8), and (iii) Time for end of mass cell migration (TEMCM) which was defined as the time when 95% of the wound area was covered. It should be readily understood by those skilled in the art that other outcome measures and parameters related to the migration process may be defined and derived from the A-t plots. Descriptive statistics which included means, medians, SDs and ranges was obtained for each of the above outcome measures.

### Results

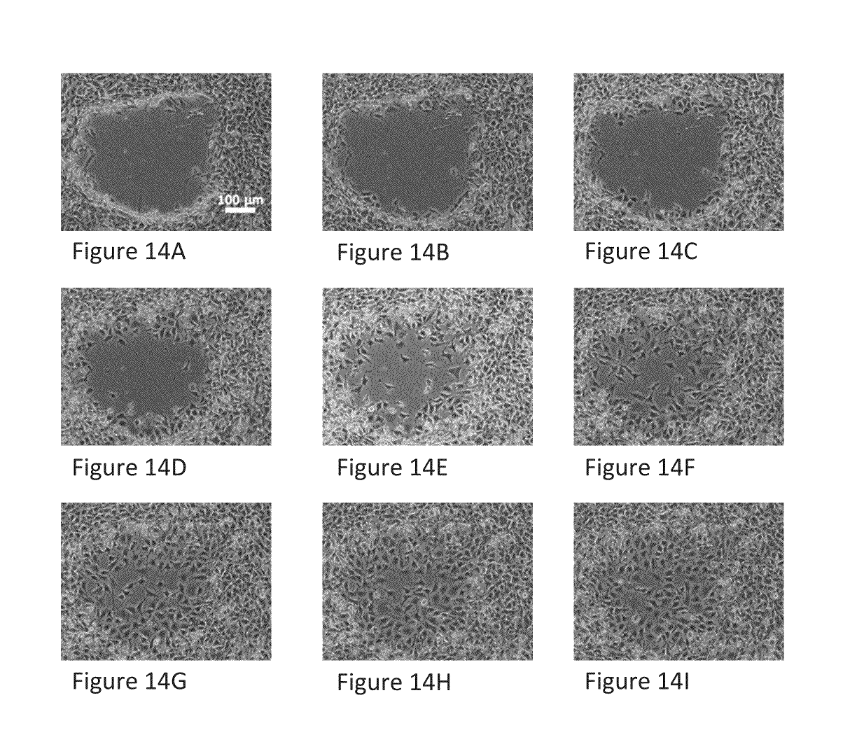

The process of wound coverage by the migrating cells is shown in the example time sequence of micrographs in FIG. 14. Specifically, the shape of the wounds immediately after inflicting the damage is close to circular, with well-defined curved boundaries, as seen in micrograph (a). Next, cells slightly retreat, but the boundaries of the wound are still well-defined. Then, some “pioneer” cells start migrating into the damage area, heading towards the center of the wound, as seen in micrograph (b), (c) and (d). It appears that around the time when these individual pioneer cells start moving, they migrate faster with respect to the colony as a mass, but groups of other cells then follow these pioneer cells, as seen in micrograph (e) and (f). It also appears that the pioneer cells may change their velocity over time. Given the variance in velocities of the cells—some migrating individually (the pioneers) and some in groups—the curved boundaries are not identifiable on the micrographs anymore at this stage. Finally, as cells become denser within the damage region and as coverage of the wound becomes more complete, movements of the cells decay, as seen in micrograph (h) and (i). This can be used for automatic image processing of images to characterize wound healing, or to guide image acquisition to look for such groups and/or to measure distances.

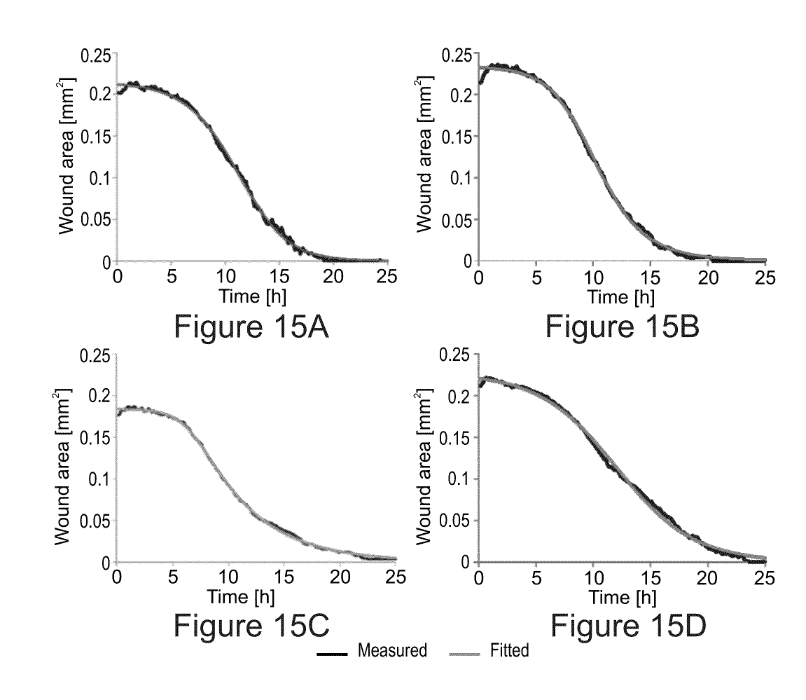

The image processing method described above produced quantitative A-t plots for the entire set of 8 experiments (FIG. 15). The Richards function fits served for describing the experimental A-t curves (curve fitting coefficients are listed in FIG. 16), providing normalized root mean square errors of only 1.9-3.8% (FIG. 16). Cell migration rates ranged between 0.010-0.028 mm²/h and averaged at 0.019±0.006 mm²/h (mean±SD). The TOMCM ranged between 5-9.4 hours and the TEMCM ranged between 14-26 hours.

### C. Detailed Description of Experiment for Measuring the Influence of Ischemic Factors on the Migration Rates of Cell Types Involved in Cutaneous and Subcutaneous Pressure Ulcers

The inventors conducted experiments to evaluate the influence of ischemic factors on the migration rate of NIH3T3 fibroblasts, 3T3L1 preadipocytes and C2C12 myoblasts, which could all be affected by pressure ulcers.

### Description of an Embodiment of a Method Used for Measuring Cell Migration

Using an in vitro cell culture model, the method determined the influence of ischemic factors: low temperature (35° C.), low glucose (1 g/l) and acidic pH (6.7) on the migration rate of NIH3T3 fibroblasts, 3T3L1 preadipocytes and C2C12 myoblasts, affected by pressure ulcers. Cell migration into a local damage site, produced by crushing cells under a micro-indentor, was monitored over ˜16 hours under controlled temperature and pH conditions.

### Cell Culturing and Experimental Design

NIH3T3, 3T3L1 and C2C12 cells were cultured in growth medium (GM) composed of Dulbecco's modified Eagle medium (DMEM) with 4.5 g/l D-glucose, supplemented with 10% fetal bovine serum (FBS), 2 mM glutamine, 0.1 μg/ml penicillin and 0.1 μg/ml streptomycin. Cells of each type were thawed from liquid nitrogen storage and cultured in 25 cm² flasks for 3 days in an incubator at 37° C. and 5% CO₂. Cells were then passaged at a split ratio of 1:40, up to passage 14 prior to use in experiments, by washing the cultures twice with PBS, applying 1 ml trypsin-EDTA (0.25%/0.25%) for 2-5 minutes, adding 2 ml GM, centrifuging at 300 g for 7 minutes and removing the supernatant. Towards the migration studies, cells were transferred into 6-well plates, up to near confluency. Finally, in each well, a local damage site (wound) was created by slowly lowering a rigid micro-indentor (size 0.46×0.38 mm) to compress the culture's surface, which thereby induced an approximately circular damage area at the center of the wells.

Three experimental conditions were used for simulating the different ischemic factors in isolation: (i) “Low temperature”, by culturing cells post infliction of the wound in an incubator set to 35° C. and 5% CO₂, using regular GM. (ii) “Low glucose”, where a D-glucose concentration of 1 g/l in the DMEM (Biological Industries) was used instead of the normal DMEM (which contains 4.5 g/l D-glucose). (iii) “Acidosis”, where lactic acid (L1875, Sigma) and 55 mM HEPES were added to the culture media, resulting in a pH of 6.7 (normally, the pH was 7.6). Control conditions were normal glucose (4.5 g/l), culturing temperature of 37° C. and pH of 7.6 in the media. Six (6) trials were conducted in each experimental condition, per each cell type, and digital micrographs were acquired every 2 hours for up to 16 hours (i.e. if complete coverage of the wound did not occur before that time). These time-lapse micrographs were captured by a camera (DS-Fil, Nikon) connected to an optical phase contrast microscope (Eclipse TS100, Nikon) that was set to the x10 objective. The resolution of the captured micrographs was 2560×1920 (3 pixels per micron) and the digital field of view (FOV) was 850×640 μm.

### Data and Statistical Analyses

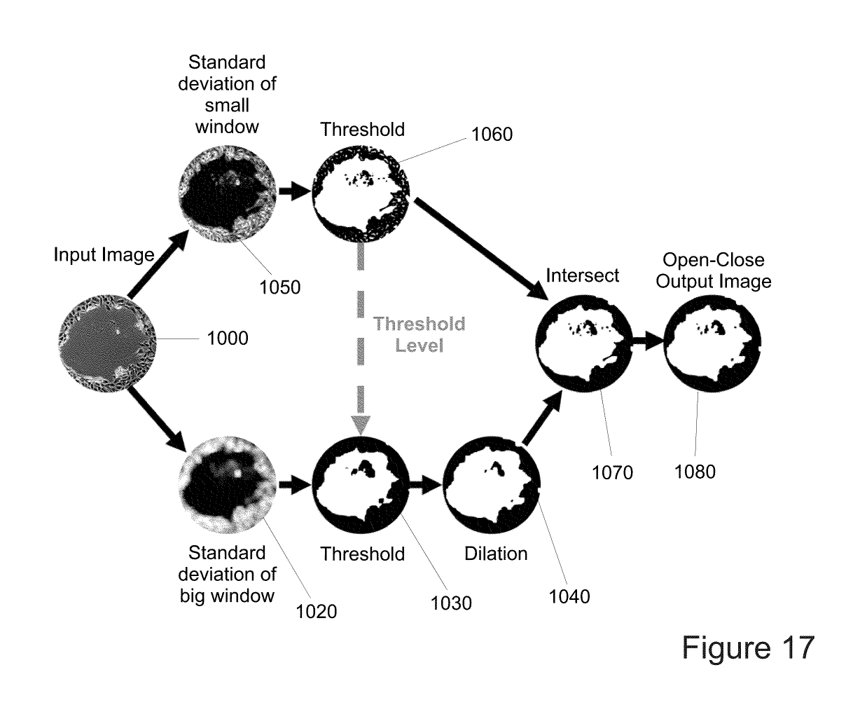

The acquired time-lapse micrograph data were analyzed using a custom image processing technique designed to non-destructively and quantitatively determine the wound area (FIG. 17). Specifically, micrographs 1000 were segmented into two regions: denuded areas (“wound”) and cell-populated areas. The segmentation process distinguishes between the two regions based on local texture homogeneity measures, where the denuded areas are characterized by higher local texture homogeneity with respect to cell-populated areas. Standard Deviation (SD) of pixel intensities is used as the measure of texture homogeneity; lower SD values correspond to higher texture homogeneities, and vice versa. In order to map the homogeneity of an entire micrograph, the SD is calculated at the location of each pixel in the image using a moving, square-shaped window. The histogram of the SD map, which peaks around SD=0 (denuded areas) and, also, at another, positive SD value (cell-populated areas) is then calculated. This histogram is used to determine the SD threshold value for the segmentation of the micrograph, which is set as half the positive peak value (associated with the cell-populated areas), hence, the SD threshold is at the valley between the two peaks of the SD histogram.

Mapping the SD in each micrograph 1000 and subsequent segmentation of the micrograph to denuded (wound) and cell-populated areas using the SD thresholding technique described above is performed twice per each image, using a smaller 1050 (10μm-sized) and a larger 1020 (30 μm) window. The threshold level 1030 and 1060 for the segmentation is determined from the SD map obtained while using the smaller window (FIG. 16). Each micrograph 1000 is segmented using small and large windows. The segmentation process conducted using the large window 1020 is further enhanced by morphological dilation 1040, performed using a rectangular structuring element which is half the size of the large window (15 μm) (FIG. 17). The algorithm then combines the outcomes from the segmentations performed using the two window sizes by a pixel-wise intersection 1070, that is, a pixel is said to belong to the wound area only if it has been identified as such by both the small and large window segmentations (FIG. 17). Lastly, “noisy” areas, if such exist, are filtered using morphological “opening” (operation of erosion followed by dilation) and “closing” (dilation followed by erosion) to produce the final output image 1080 (FIG. 17). Numerous micrographs were taken and visually and quantitatively verified the cell-populated and denuded area data calculated by the algorithm.

The algorithm was applied to each individual micrograph along the time sequence, to ultimately produce the wound area over time plot (A-t plot). A Richards function (non-symmetric sigmoid), given by

equation 6 was then fitted to the experimental A-t plots, where α, tₒ, ΔT and ν are the coefficients of the fit, calculated (Matlab, Mathworks) to satisfy the minimum mean squared error objective function.

The maximum migration rate (MMR) (in [%/h]) was evaluated as the maximum value of the derivative (dA/dt) of the Richards fit (eq. 6), normalized by the initial wound area aₒ, given by equation (9):

$$MMR = \frac{1}{{a}_{0}} \times \frac{α}{Δ {T ( 1 + v )}^{\frac{1 + v}{v}}} \times 100 \qquad ( 9 )$$

An estimate for the time-dependent number of cells that have migrated into the wound, N_{c}, was obtained analytically using this method, as given by equation (10):

$${N}_{c} ( t ) = \frac{{a}_{0} - area ( t )}{s} \qquad ( 10 )$$

where s is the mean area of a single cell, set to equal 1060 μm², 1470 μm² and 1730 μm² for the NIH3T3, 3T3L1 and C2C12 cells, respectively (based on own measurements). The time when a specific portion of the wound has been covered by the migrating cells is given by equation (11):

$${t}_{x} = {t}_{0} + Δ T ln ( \frac{{α}^{v} - {{a}_{0}^{v} ( 1 - x )}^{v}}{{{va}_{0}^{v} ( 1 - x )}^{v}} ) \qquad ( 11 )$$

where x is a parameter describing the extent of coverage of the wound by the migrating cells, which can range between 0 (none) and 1 (full coverage). The time point at which 10% of the wound area has been covered by migrating cells is defined as the time for onset of mass cell migration (TOMCM), and, the time when 95% of the wound area has been covered as the time for end of mass cell migration (TEMCM). Using these definitions, the average migration rate (AMR) (in [%/h]) was evaluated as the average slope of the “step” phase in the Richards fit (eq. 6), i.e. between the TOMCM and TEMCM time points, having normalized again with respect to the initial wound area, as given by equation (12):

$$AMR = \frac{1}{{a}_{0}} \times \frac{area ( {t}_{0.1} ) - area ( {t}_{0.95} )}{{t}_{0.95} - {t}_{0.1}} \times 100 \qquad ( 12 )$$

The following outcome measures were recorded for each trial: MMR (eq. 9), AMR (eq. 12), TOMCM for x=0.1 and TEMCM for x=0.95 (eq. 11). Each of these outcome measures was compared across the different cell types for the control condition (n=6 repetitions per cell type), as well as across experimental conditions (low temperature, low glucose and acidosis) for the same cell type (n=6 repetitions per experimental condition). Comparisons were made using one-way analysis of variance (ANOVA) for the factor of cell type under the control condition, and, separately, for the factor of experimental condition within each cell type (SPSS, IBM). Tukey tests were conducted post-hoc to identify statistically significant differences between pairs of cell types or experimental conditions. A p-value lower than 0.05 was considered significant.

### Results

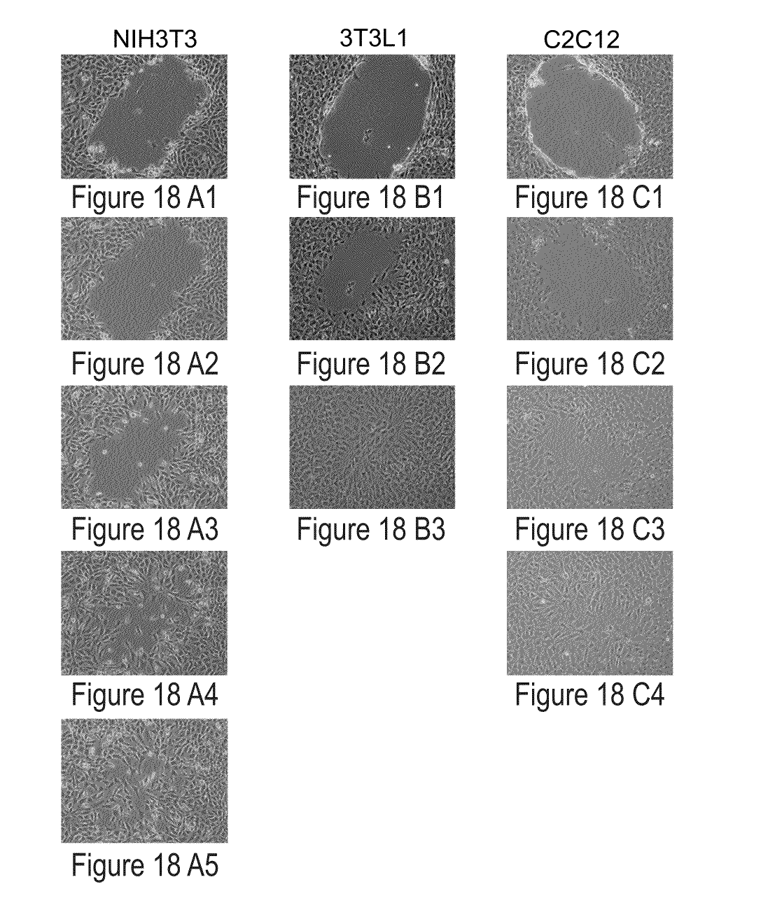

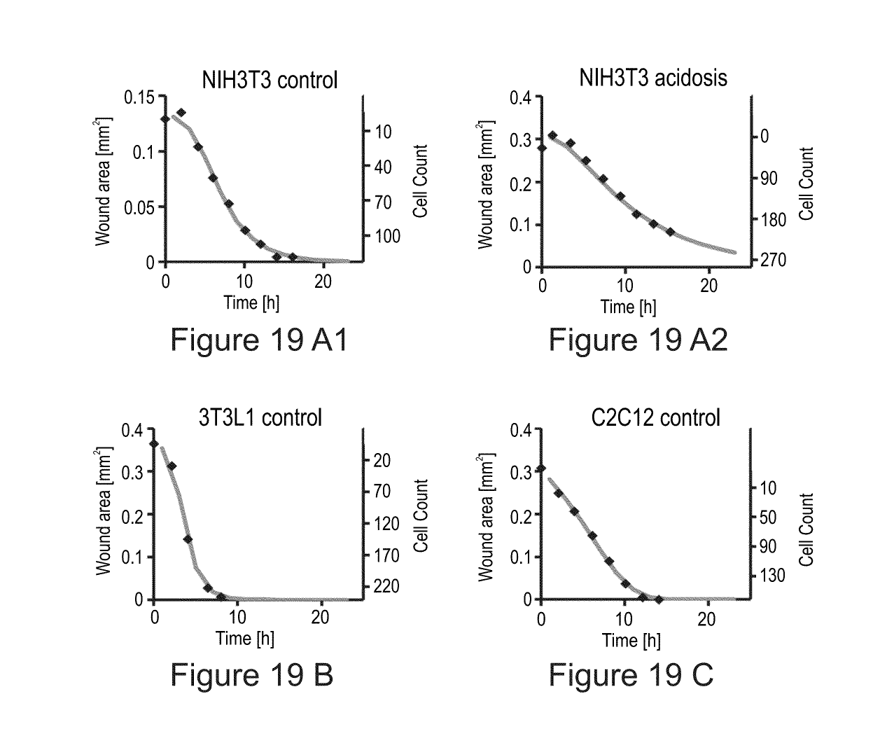

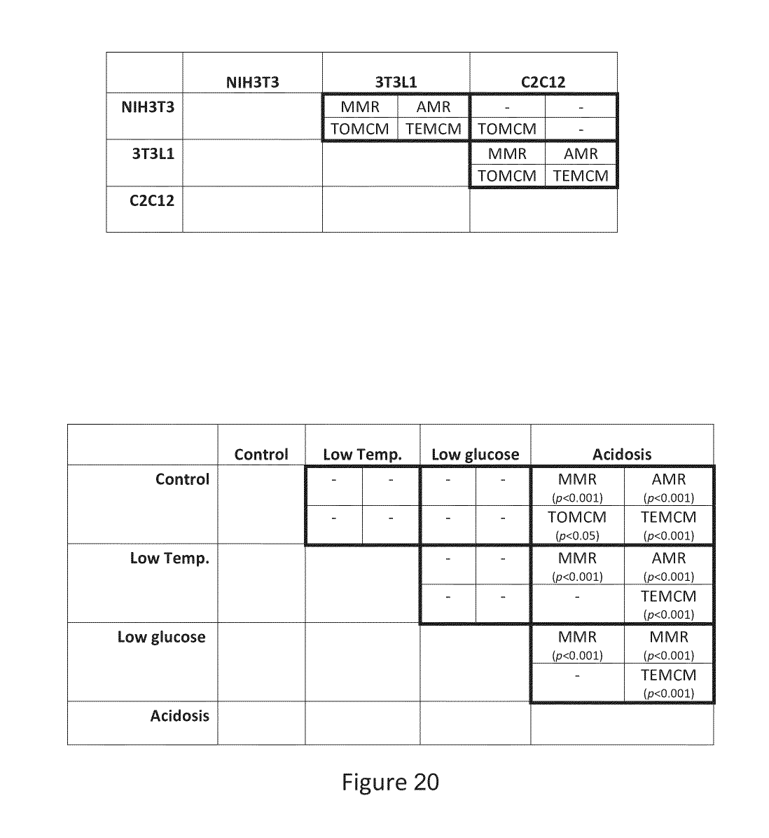

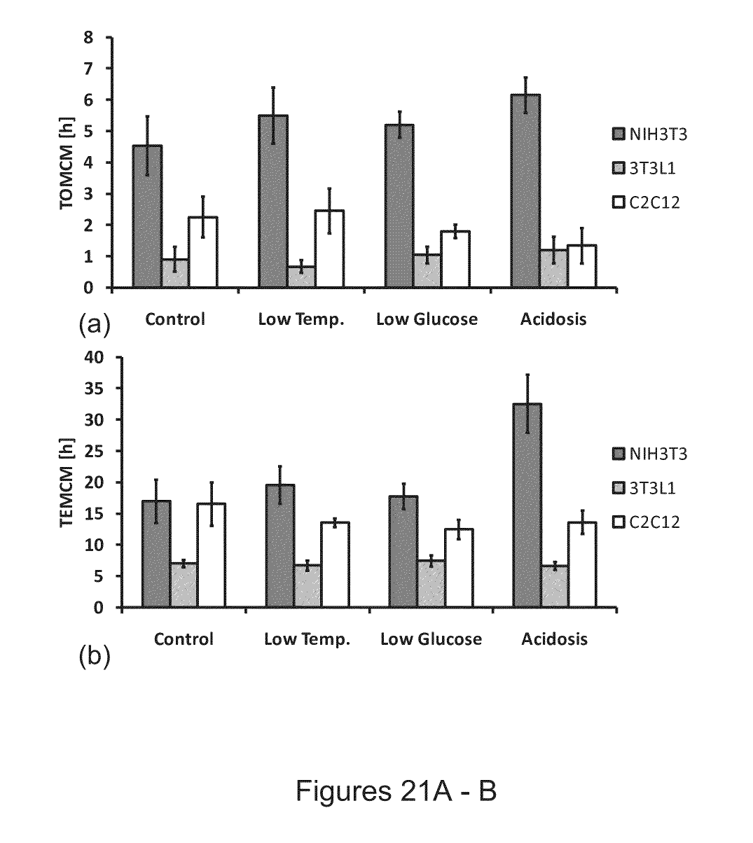

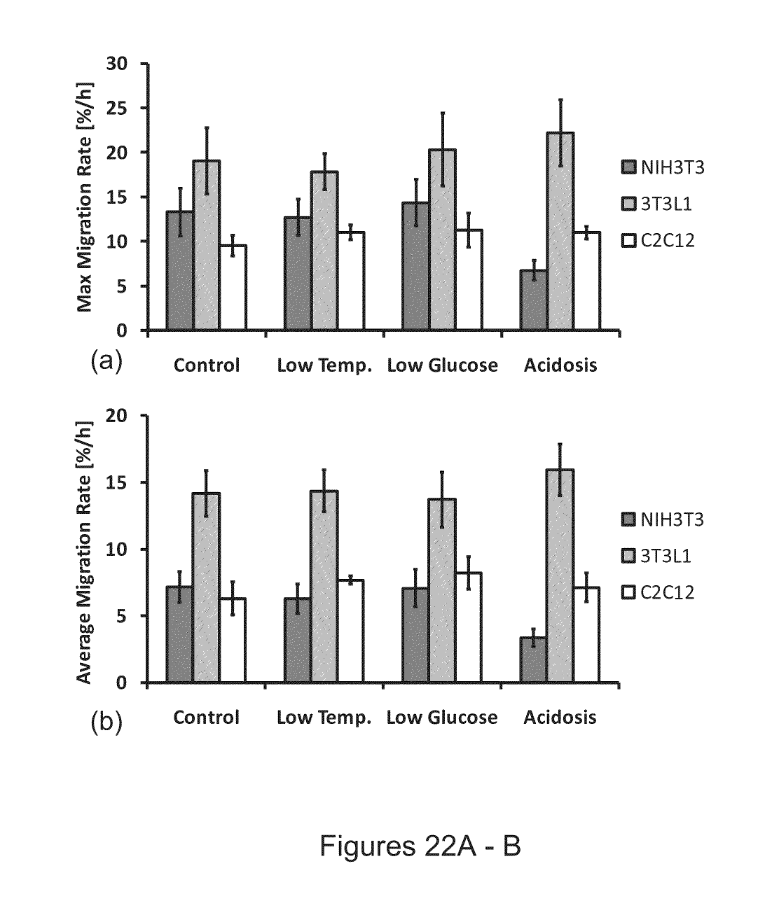

The migration kinetics of the cultures from the NIH3T3, 3T3L1 and C2C12 cell types differed visually (FIG. 18) as well as in their quantitative time courses (some time course and intra-wound cell count examples are provided in FIG. 19). The ANOVA and post-hoc Tukey tests, comparing the migration outcome measures of the three cell types under the control condition (FIG. 20), revealed statistically significant differences across all properties excluding the comparisons between the NIH3T3 and C2C12 cells—where only TOMCM was distinguishable. FIG. 20 includes two tables: the upper table provides statistical differences and similarities across the maximum migration rate (MMR), average migration rate (AMR), time for onset of mass cell migration (TOMCM) and time for end of mass cell migration (TEMCM) between controls of the 3 cell types. The lower table provides statistical differences and similarities across the maximum migration rate (MMR), average migration rate (AMR), time for onset of mass cell migration (TOMCM) and time for end of mass cell migration (TEMCM) across the experimental conditions for the NIH3T3 cell type. Any statistical difference in a given property is marked by the abbreviations of the property (p<0.001 for all such cases) or otherwise “-” indicates statistically indistinguishable results in both tables. In the 3T3L1 cultures, AMR was consistently higher and TEMCM was consistently lower than in the other cell types, across all conditions (FIGS. 21, 22), hence indicating that the 3T3L1 cells were the fastest in covering the wounds (also shown in FIG. 18). The MMR of the 3T3L1 cells was overall higher than those of the other cell types. The TOMCM of the 3T3L1 cells was lower than those of the other cell types for all the experimental conditions except acidosis, that is, the 3T3L1 cells also started migrating earlier (FIG. 22). The faster cells were the 3T3L1 fibroblast-like and the NIH3T3 fibroblast cells, hence the C2C12 myoblast type was slower in migrating with respect to the fibroblast/fibroblast-like cells (FIG. 21). The results were as expected as myoblast cell type migrate slower than fibroblast/fibroblast-like cells, thereby demonstrating the validity of the method.

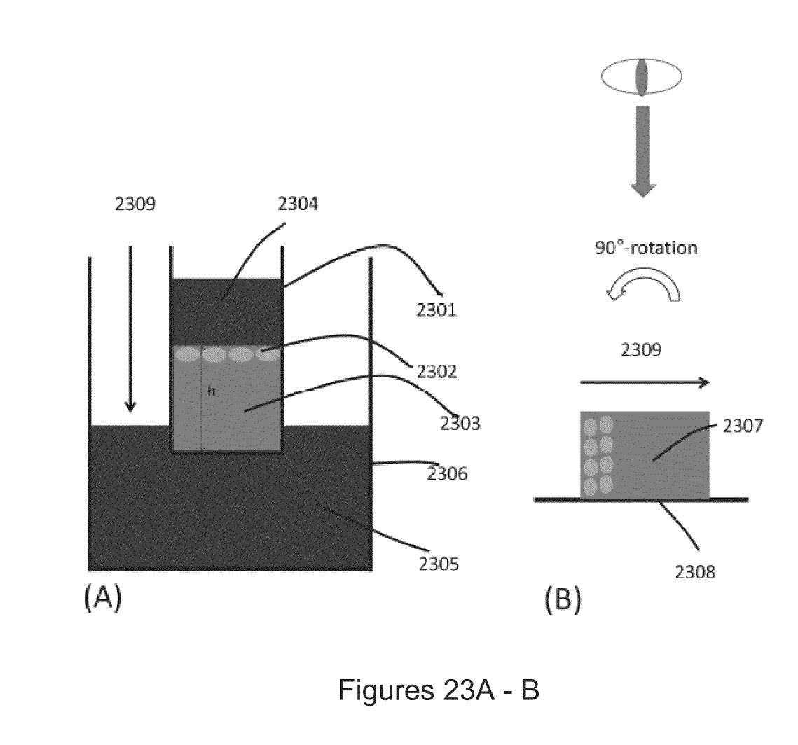

The only cell type which was affected by the ischemic factors that were applied to the cultures post infliction of the wound was the NIH3T3 type, and the only influential factor for this particular cell type was acidosis (FIG. 20). Specifically, for the NIH3T3 cells, acidosis affected the values of all the migration outcome measures, significantly slowing down these cells, as opposed to low temperature and low glucose which did not significantly affect any migration property (FIG. 20). The acidosis condition lowered the MMR and AMR values of the NIH3T3 cells significantly and considerably (FIGS. 19, 21), and it consistently increased their TEMCM (FIG. 19, 22). The acidosis condition also delayed the onset of migration for the NIH3T3 cells, as evident in a statistically significant increase in their TOMCM with respect to the control condition (FIG. 22 and FIG. 23). The only ischemic factor applied herein which resulted in partial wound coverage cases was acidosis (FIG. 19), whereas all other experimental conditions always produced a complete wound coverage, for the NIH3T3 as well as for the other cell types.

### D. Detailed Description of Experiment for Measuring Confluency and Cell Migration Rate in a Three-Dimensional Construct

The inventors conducted an experiment to evaluate the performance of an exemplary method for determining confluency and cell migration rate in a three-dimensional construct, in this example a hydrogel matrix.

### Description of an Embodiment of a Method Used for Measuring Confluency and Cell Migration Rate in a Three-Dimensional Hydrogel Based Matrix

The confluency percentage and cell migration rate of 3T3L1 (pre-adipocyte) cells through the hydrogel based matrix was determined by acquiring and processing micrographs of the cell culture at 5 hours and at 24 hours post seeding.

### Cell Culturing and Experimental Design

3T3L1 (pre-adipocyte) cells were obtained from the American Type Culture Collection (ATCC). Cells were thawed from liquid nitrogen storage into 25 cm2 flasks and kept in an incubator at 37° C. and 5% CO₂. Cells were maintained in a growth medium (GM) comprised of Dulbecco's modified Eagle's medium (DMEM) supplemented with 10% fetal bovine serum (FBS), 2 mM Glutamine and 1% penicillin and streptomycin antibiotic mixture (All GM materials were obtained from Biological Industries Co., Israel). Optionally, an equivalent growth medium may be used. In preparation, cells were cultured in 75 cm2 flasks and passaged every 3 or 4 days at a split ratio of 1:10 by washing them twice with PBS, applying 1 ml Trypsin-EDTA solution (0.25%/0.05%) for 2-5 minutes, adding 2 ml GM, centrifuging with 300 g for 7 minutes and removing the supernatant. Optionally, equivalent methods of cell passaging may be used.

Oxi-HA (Oxidized hyaluronic acid) and ADH (Adipic acid dihydrazide) were prepared according to the protocol of Su et al. (2010). The optically transparent hydrogel was prepared in the bottoms of 24-well hanging cell culture inserts (Millicell single-well hanging inserts PET 1.0 μm, Millipore), (2301, FIG. 23A) by mixing volumes of 2000 and 500 of Oxi-HA and ADH, respectively. After formation of the hydrogel construct (2303), 5×106 3T3L1 cells (2302) which were suspended in 100 μl of GM (2304) were added onto the top surface of the construct. In some embodiments, cells may be added to any surface of the construct.

To induce a chemotaxis stimulus for directional migration, additional 600 μl of GM (2305) were added to the space between the hanging cell insert (2301) and well (2306), such that the surface level of the GM reached slightly above the bottom of the cell insert. The cultures were then placed inside an incubator to allow cells to migrate.

In order to acquire micrographs of the migrating cells in the hydrogel construct, the hydrogel was stained with a 4′,6-diamidino-2-phenylindole (DAPI, ab104139, Abcam Co.), fluorescent marker for visualization of the cell nuclei under a fluorescence microscope. In some embodiments, other chemical stains may be used, for example Cell Tracker Green (CTG) fluorescent stain. In some embodiments, cells may not be stained at all.

Micrographs were acquired at two time points, the first at 5 hours and the second at 24 hours post-seeding. In some embodiments, other time points may be chosen for acquiring micrographs.

At 5 hours post seeding, the micrograph was acquired from a first section of the hydrogel construct. At 24 hours post seeding, as shown in FIG. 23B, the micrograph was acquired from a second section 2307 of construct 2303.

Both micrographs were captured using a fluorescence microscope (Axiovert 40 CFL, Zeiss Co.) connected to a digital camera (DS-Fil, Nikon). The resolution of all captured micrographs was 3 pixels per micron, and the image size was 2560×1920 pixels.

### Data and Statistical Analysis

According to an embodiment of the image processing algorithm, similarly to the method applied in experiment A above, the micrographs of the first section (at 5 hours) and the second section (at 24 hours) were segmented into regions of denuded areas and cell-populated areas based on local texture homogeneity measures, using standard deviation mapping of pixel intensities.

A brief review of the applied algorithm is presented hereby. Two window sizes for each micrograph were selected according to a cell-group scale and an individual cell scale. In this example, window sizes of 33 μm (large window) and 11 μm (small window) were selected for performing calculations to determine texture homogeneity. Optionally, other window sizes may be selected. The selected big and small windows were parallel processed by applying thresholds to the SD arrays (in this example a manual threshold of 0.04 was applied to the 5 hour micrograph, and an automatic threshold of 0.0196 was applied to the 24 hour micrograph). The results of segmenting the windows into cell populated areas versus denuded areas were combined by a pixel wise intersection (a pixel is said to belong to a denuded or cell populated area only if it has been identified as such by both window segmentations) to determine confluency.

The average cell migration distance in the gel was determined for each time point. Given that in this example the cell migration is dominantly unidirectional, the average cell migration distance was calculated as the ratio of the cell-populated area over the total gel height. In this example, the typical dimensions of the hydrogel cell culture construct included a width of 6.2 mm, and a height of 8.3 mm.

The average cell migration rate was then determined by the ratio of the difference in calculated cell migration distance between both time points, divided by the time interval between them.

### Results

The micrographs acquired from the three-dimensional hydrogel construct were analyzed for determining confluency and cell migration rates. Example quantitative data are provided below.

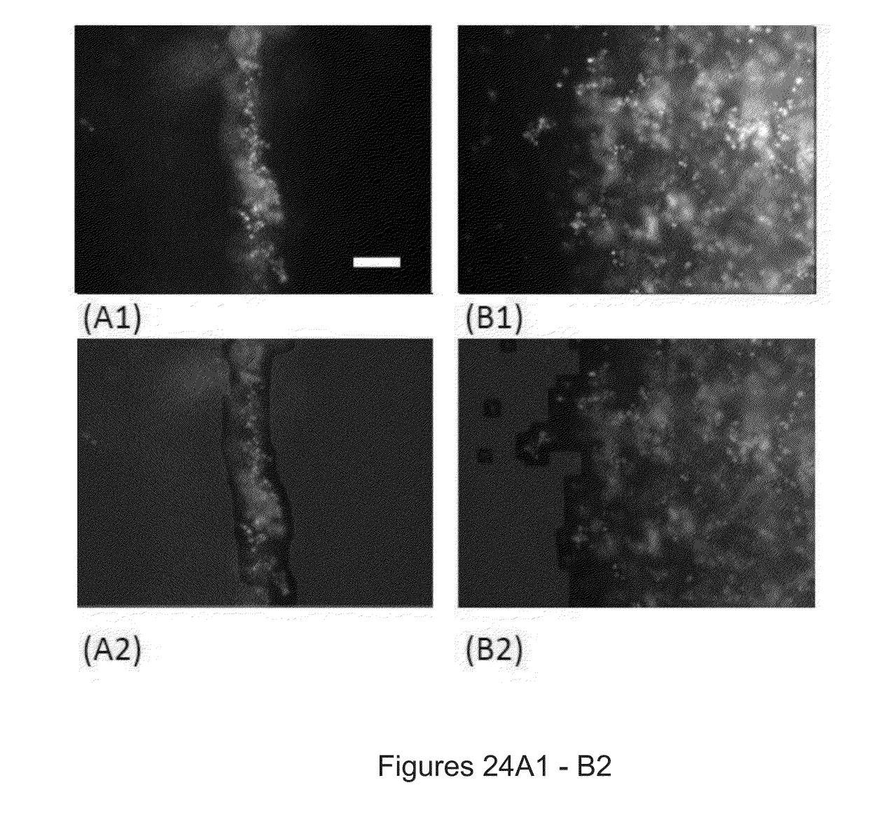

At 5 hours post seeding, the micrograph acquired from the top surface of the hydrogel construct (shown in FIG. 24 A1) shows DAPI stained cell nuclei appearing in a thin vertical stripe, the width of the stripe comprising approximately 2-6 rows of cells (with a mean of ˜4 rows of cells). The equivalent processed micrograph is shown in FIG. 24 A2, red markings indicating denuded areas. At this time point (5 hours post seeding), the cell-populated area, as calculated by the applied algorithm, covered 14.2% of the total micrograph area (14.2% confluency). By calculating the ratio of the cell-populated area over the total gel height, the equivalent cell migration distance was estimated at 119.5 μm.

To examine the migration of cells through the three-dimensional hydrogel construct 24 hours post seeding, a second section was extracted. FIG. 24 B1 shows the micrograph of the DAPI stained cell nuclei in the sliced section of hydrogel at 24 hours post seeding, and FIG. 24 B2 shows the equivalent processed micrograph, red markings indicating denuded areas. At this time point (24 hours post seeding), a confluency of 73% was calculated. The cell migration distance was estimated by calculating the ratio of the cell populated area over the total construct height (h, FIG. 23A), resulting in a distance of 623-853 μm.

According to the estimated migration distances at 5 hours and at 24 hours post seeding, the directional migration rate for the 3T3L1 preadipocytes through the three-dimensional construct was calculated, resulting in a rate of 27-39 μm/h.

In the setup used herein (FIG. 23), the cells migrated in a gravitational direction, but it is important to emphasize that the cells were not “free falling” in the hydrogel. Instead, it is predicted that the cells applied cytoskeletal forces to migrate. This assumption can be supported by the fact that the stiffness of the hydrogel material (under small deformations) is greater than the estimated stiffness of the migrating cells. (The elastic modulus of the gel is approximately 7 kPa at preparation, and it then decreases to ˜2 kPa after three days, as measured in the inventor's lab. The elastic modulus of the migrating cells is mildly smaller, and estimated at 1-2 kPa (Or-Tzadikario & Gefen, 2011). Therefore it may be concluded that the cells were migrating in a solid extracellular space as opposed to a fluidic environment, where gravitation might affect the migration rate of cells.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### BIBLIOGRAPHY

1. Su W, Y., Chen Y. C. and Lin F. H., Acta Biomater 6, 3044-3055, (2010)
2. Or-Tzadikario, S., and Gefen, A., J Biomech., 44: 567-573, (2011).

What is claimed is:

1. A method for determining cell occupancy in a cell culture comprising:
electronically receiving data related to pixel intensity in an image acquired of said cell culture; and
automatically distinguishing between cell concentrations in different locations in said cell culture by detecting variations in pixel intensity between at least a first multi pixel location and a second multi pixel location.

2. The method according to claim 1, wherein variations in pixel intensity between said first multi pixel location and said second multi pixel location is indicative of a presence of cells.

3. The method according to claim 1, comprising identifying a denuded area based on a homogeneity in pixel intensity between said first multi pixel location and said second multi pixel location.

4. The method according to claim 3, comprising dilating of the denuded areas.

5. The method according to claim 1, wherein said detecting of variations in the pixel intensity is done by calculating standard deviation of the pixel intensities.

6. The method according to claim 1, comprising windowing the received data with at least one window, wherein the detecting of variations in pixel intensity is performed over the windows.

7. The method according to claim 6, wherein a large window is used for said window and is of a size of at least 50% of a shortest string of a cell in said culture.

8. The method according to claim 7, wherein an additional small window is used and is of a size of less than 50% of the size of the large window.

9. The method according to claim 6, wherein said distinguishing is performed by combining results obtained from a plurality of windows.

10. The method according to claim 1, comprising automatically determining cell movement by detecting changes in cell occupancy over time using a sequence of a plurality of images of said cell culture acquired over time.

11. The method according to claim 10, wherein estimating cell movement comprises estimating sperm motility by comparing time dependent displacements of spatial locations of cell populated areas in said images.

12. The method according to claim 10, wherein estimating cell movement comprises estimating wound healing rate.

13. The method according to claim 10, wherein estimating cell movement comprises estimating cancer cell metastasis.

14. The method according to claim 1, wherein said determining comprises automatically determining a cell count in said cell culture based on a size of areas occupied by cells and an average size of cells.

15. The method according to claim 1, wherein said determining comprises determining cell migration in a cell culture by comparing said cell concentrations and determining a change in said cell concentrations over time.

16. The method according to claim 15, wherein said determining comprises applying an asymmetric sigmoid curve-fitting function.

17. The method according to claim 16, wherein said curve-fitting function includes a Richard's function.

18. The method according to claim 1, comprising automatically segmenting said image to areas occupied by cells and areas denuded of cells by thresholding variation levels in pixel intensity.

19. The method according to claim 1, wherein said determining comprises determining cell confluency in a section of a three-dimensional cell culture construct, said construct extending at least 3 mm in each direction.

20. The method according to claim 19, wherein said determining comprises determining cell migration in a tissue engineered three-dimensional construct.

21. The method according to claim 19, wherein said construct comprises a chemotaxis gradient in at least two non-parallel directions.

22. The method according to claim 19, wherein said determining comprises acquiring at least one projection image of the three dimensional cell culture.

23. The method according to claim 22, wherein said image is acquired from a section selected from said three dimensional construct, said section having a thickness small enough to visualize cells therethrough.

24. A device for measuring cell occupancy in a cell culture comprising circuitry configured to distinguish between cell concentrations in different locations in said cell culture by detecting variations in pixel intensity between at least a first multi pixel location and a second multi pixel location.

25. The device according to claim 24, wherein said circuitry is configured to calculate a percentage of confluency in said cell culture.

26. The device according to claim 24, wherein said circuitry is configured to apply a windowing function for detecting denuded areas in the image by windowing the received data with at least one window.

27. The device according to claim 26 wherein the circuitry is configured to apply a large windowing function and a small windowing function substantially in parallel for detecting denuded areas in the image by estimating texture variability in said windows.

28. The device according to claim 24, wherein said device is incorporated in a system for detecting cell occupancy in a cell culture, said system further comprising:
a microscope;
an image detector; and
a source of a continuous spectrum of light.

29. The system according to claim 28, wherein the source of a continuous spectrum of light is indoor room illumination.

30. The system according to claim 28, wherein said device is incorporated within said microscope.

31. The system according to claim 28, further comprising:
an incubator; and
an add-on cartridge adapted to accommodate a cell culture, said cartridge viewable under said microscope.

32. The system according to claim 31, wherein said add-on cartridge includes a wound inflicting device for causing micro-damage to said cell culture.

33. A method for detecting confluency in a three dimensional construct, comprising:
imaging a three dimensional construct comprising migrating cells, said construct having a shortest dimension of at least 1 mm; and
analyzing an acquired image to detect at least one of confluency and cell migration using an automatic device.
